(19) United States
(12) Patent Application Publication
(10) Pub. No.: US 2002/0175948 A1
(43) Pub. Date: Nov. 28, 2002

(54) Graphical user interface method and apparatus for interaction with finite element analysis applications

(76) Inventors: Eric W. Nielsen, Peoria, IL (US); Steven R. Storm, Edelstein, IL (US)

Correspondence Address: W. Bryan McPherson III, Caterpillar Inc., Intellectual Property Department, AB6490, 100 N.E. Adams Street, Peoria, IL, 61629-6490, US

(21) Appl. No.: 09/863,720

(22) Filed: May 23, 2001

(51) Int. Cl. G06F 3/14

(52) U.S. Cl. 345/781

(57) ABSTRACT

Designing engineering models using finite element analysis applications often involves the knowledge and memorization of numerous commands and codes to efficiently draw and analyze engineering models. If not done accurately, or if not done in a time efficient manner, unacceptable loss can occur because production deadlines are delayed or not met altogether, for example. The graphical user interface method and apparatus for interaction with finite element analysis applications represented in various embodiments makes use of the computer and finite element analysis applications very effective. The graphical user interface is based upon child windows with well-defined characteristics which allow a user to create, modify, and manipulation drawings in an efficient and timely manner. By being able to utilize these well-defined and organized characteristics, the user does not require significant training to know how to create, modify, or manipulate an engineering design model nor particular knowledge of specific commands or controls of all the various commands and controls in a typical finite element analysis application thereby allowing for an effective manner of interacting with the computer and finite element analysis software by improved ergonomic, aesthetic, and instinctive control of the graphical user interface.

### DESCRIPTION

1. Technical Field

The present invention relates generally to a user interface method and apparatus for use with finite element analysis software.

2. Background

Personal computers and finite element analysis (“FEA”) workstations for automated mesh generation of quadrilateral, triangular, hexahedral, and tetrahedral elements for solid model-based geometries almost universally now run software with a Windows™ (i.e., Windows NT™) or Unix™ based operating system. The Windows™ based operating systems include program interface functions that allow a user to define a desktop interface. Some prior FEA applications written for these operating systems, such as I-DEAS™ by Structural Dynamics Research Corporation, CUBIT™ by Sandia National Laboratories, and PATRAN™ by The MacNeal Schwendler Corporation, attached very few, if any, or only one child window to the main work area window. Generally, the sole child window, if included, consisted of a simple command line window for textual entry of commands while the main work area window consisted of a single graphics display window.

These traditional FEA applications, thus, mandated a high learning curve and inefficient interaction with the FEA application in terms of learning how to utilize the textual command line for creation, manipulation, design, and analysis of finite elements and models. Specifically, failure to provide user capabilities to quickly, efficiently, and easily utilize finite elements analysis software applications can delay engineering design and analysis projects, and, in turn, production timetables, causing large economic loss.

The present invention takes complete advantage of multiple child windows and tabbed-based menuing capabilities by using gadgets within interface elements such as iconic buttons, icons, toolbars, tabs, taskbars, etc. that control functions associated with the main graphics window. The time saved in training because of an easy to use method and/or apparatus, and in making quicker and more correct design models, has the potential for large savings.

### SUMMARY OF THE INVENTION

The invention relates to a new and improved graphical user interface for use with FEA rendering software. Use of the interface has improved the way a user interacts with the computer and FEA software by improving the ergonomic, aesthetic, and instinctive feel of the graphical user interface.

In one aspect of the present invention, a method of presenting a graphical user interface for a finite element analysis application on an electronic display device is disclosed. The graphical user interface includes launching a parent graphics window on the electronic display device for displaying an image and attaching a task window to the parent graphics window for geometry creation, manipulation, and meshing of entities within the parent graphics window. The first interface element of the task window has a first tab identifier and includes at least one of a first iconic button adapted to providing creation capabilities of at least one of a vertex entity and curve entity and surface entity and volume entity and brick entity and sphere entity and cylinder entity and pyramid entity and torus entity and frustum entity as well as a second iconic button adapted to providing modification capabilities of entities by at least one of webcutting and imprinting and cleaning and combining and boolean operations and healing and positioning and scaling and separating and splitting and copying and merging and tweaking.

In another embodiment of the present invention an apparatus for presenting a graphical user interface for a finite element analysis application on an electronic display device is disclosed. The apparatus includes a computer programmed to launch parent graphics window on the electronic display device for displaying an image and attaching a task window to the parent graphics window for geometry creation, manipulation, and meshing of entities within the parent graphics window. The first interface element of the task window has a first tab identifier and includes at least one of a first iconic button adapted to providing creation capabilities of at least one of a vertex entity and curve entity and surface entity and volume entity and brick entity and sphere entity and cylinder entity and pyramid entity and torus entity and frustum entity as well as a second iconic button adapted to providing modification capabilities of entities by at least one of webcutting and imprinting and cleaning and combining and boolean operations and healing and positioning and scaling and separating and splitting and copying and merging and tweaking.

In still another embodiment of the present invention, a method of presenting a graphical user interface tabbed-based menuing system on an electronic display device is disclosed. The graphical user interface tabbed-based menuing system includes launching a parent window on the electronic display device for displaying an image and attaching a child window to the parent window. The child window includes a first interface element that has a first tab identifier and at least one iconic button where selection of the at least one iconic button associated with the first interface element outputs a second interface element that has a second tab identifier where the second interface element overlaps the first interface element except for the first tab identifier.

In yet another embodiment of the present invention an apparatus for presenting a graphical user interface tabbed-based menuing system on an electronic display device is disclosed. The apparatus includes a computer programmed to launch a parent window on the electronic display device for displaying an image and attaching a child window to the parent window. The child window includes a first interface element that has a first tab identifier and at least one iconic button where selection of the at least one iconic button associated with the first interface element outputs a second interface element that has a second tab identifier where the second interface element overlaps the first interface element except for the first tab identifier.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description, when read with the accompanying drawings, in which:

FIG. 1 is a diagram of computer systems that are suitable for practicing the preferred embodiment of the present invention.

FIG. 2 is a graphical user interface that employs the window components of the preferred embodiment of the present invention.

FIGS. 3A-3D illustrate isolated appearances and interface elements within textual input window 24.

FIGS. 4A-4Q illustrate isolated appearances and interface elements within task window 26 related to “Create” button 60.

FIGS. 5A-5B also illustrate isolated appearances and interface elements within task window 26.

FIG. 6A illustrates an isolated appearance and interface element within task window 26 related to “Modify” button 61.

FIG. 7A illustrates an isolated appearance and interface element within task window 26 related to “Virtual” button 62.

FIG. 8A illustrates an isolated appearance and interface element within task window 26 related to “Groups” button 63.

FIG. 9A illustrates an isolated appearance and interface element within task window 26 related to “Meshing” button 64.

FIG. 10A illustrates an isolated appearance and interface element within task window 26 related to “Display” button 65.

FIG. 11A illustrates an isolated appearance and interface element within task window 26 related to “Import” button 66.

FIG. 12A illustrates an isolated appearance and interface element within task window 26 related to “Validate” button 67.

FIG. 13A illustrates an isolated appearance and interface element within task window 26 related to “Export” button 68.

FIG. 14A illustrates an isolated appearance and interface element within task window 26 related to “Settings” button 71.

FIG. 15A illustrates an isolated appearance and interface element within task window 26 related to “Measure” button 74.

FIG. 16A illustrates an isolated appearance and interface element within property input window 28.

FIGS. 17A-17C illustrate isolated appearances and interface elements within entity tree window 30.

FIG. 18A illustrates an isolated appearance and interface element within textual output window 32.

FIGS. 19A-19B illustrate pick toolbar 510 and display toolbar 512 within the toolbars 34 area.

### DETAILED DESCRIPTION

A graphical user interface for interaction with finite element analysis (“FEA”) applications is described. In the following detailed description numerous specific details are set forth in order to provide a thorough understanding of the invention. However, it will be understood by those skilled in the art that the present invention may be practiced without these specific details. For example, the invention is not limited in scope to the particular type of computer, personal device assistant, network, combination of hardware circuitry and software, software language, server environment, or to particular source for instructions executed by a computer system.

The method and apparatus for a graphical user interface for interaction with FEA applications in accordance to the present invention is built from a combination of off-the-shelf hardware and software packages and custom software. The graphical user interface is intended to allow users to interact with a computer and FEA software through an improved ergonomic, aesthetic, and instinctive feel of the graphical user interface.

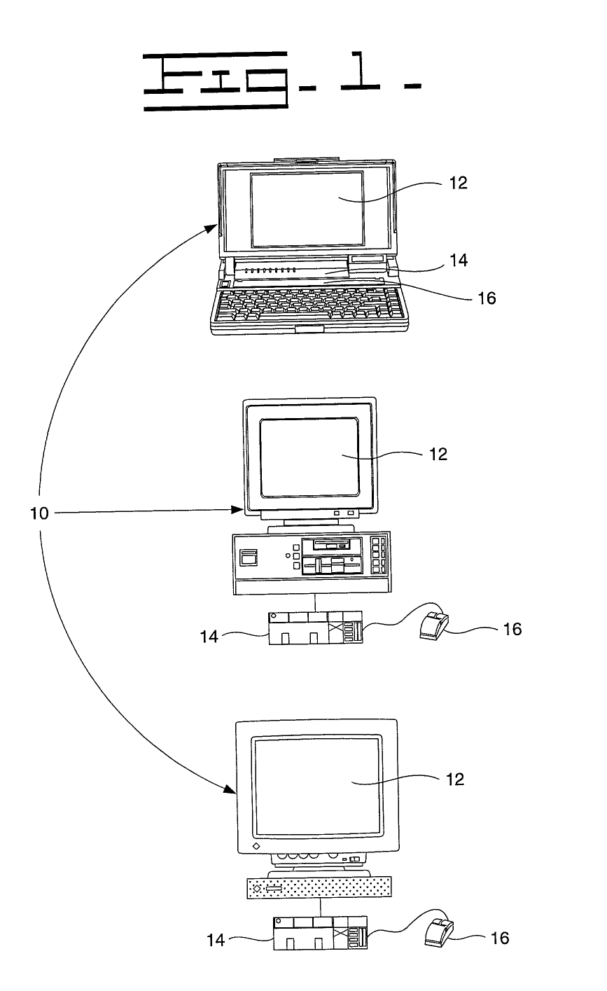

An embodiment of the computer system 10 that is suitable for practicing the preferred embodiment of the graphical user interface of the present invention is shown in a simplified diagram in FIG. 1. The graphical user interface of the present invention may exist on any conventional personal computer, personal assistant device, or workstation running a suitable operating system such as Windows™, Windows NT™, Unix™ or Linux™, for example.

The computer system 10 preferably includes a bus, a processor coupled with the bus for processing information, and a main memory, such as RAM or other dynamic storage device, coupled to the bus for storing information and instructions to be executed by the processor. The computer system 10 preferably further includes ROM or other static storage device coupled to the bus for storing static information and instructions for the processor. A storage device, such as a magnetic disk or optical disk is also preferably provided and coupled to the bus for storing information and instructions. The computer system also preferably includes an electronic display device 12, input device (i.e., keyboard 14 and/or mouse 16), and a communication interface coupled to the bus. The communication interface provides a two-way data communication coupling to a network link that is connected to a local network. For example, the communication interface may be a local area network (“LAN”) card to provide a data communication connection to a compatible LAN or a modem to provide a data communication connection to a corresponding type of telephone line. Wireless links may also be implemented. The network link then preferably provides data communication through one or more networks to other data devices, such as through a local network to a host computer or other server-client systems for example.

Software for implementing the disclosed graphical user interface runs under a windows based operating system such as Windows NT™ commercially available from Microsoft® Corporation in Redmond, Wash. The graphical user interface software is written in an application programming language suitable for writing Windows™ applications programs. However, it is to be understood that the present invention can easily be ported to Unix providing the same “look and feel” as Windows NT™. The presently preferred embodiment of the invention was written in C++ using visual C++ programming tools including the Microsoft® Foundation Class™ library.

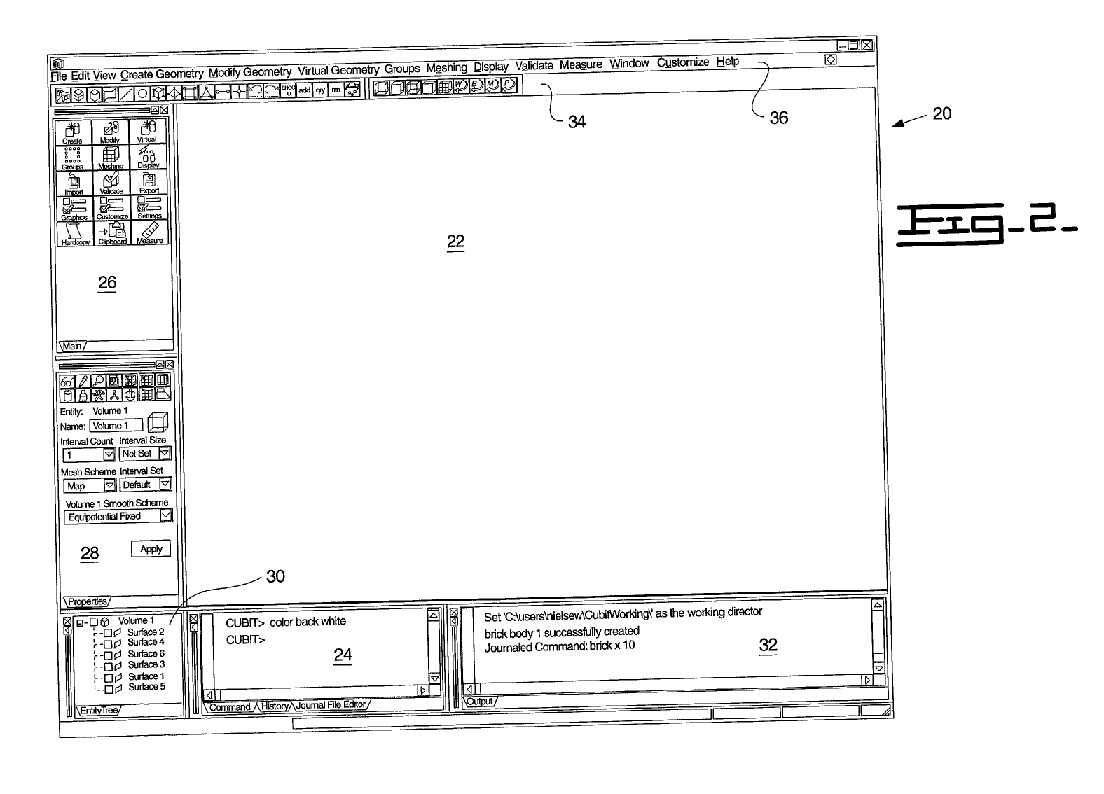

In order to fully appreciate the present invention, it is helpful to view an exemplary graphical user interface that allows a user to control the creation, presentation, and modification of a finite element in a graphics window, as generally indicated by numeral 20 in FIG. 2. By default, the main parent graphics window 22 takes up the entire FEA applications' viewing area on the visual display unit 12 for displaying a finite element model and its characteristics. The main graphics window 22 defines the user work area. In addition to the main graphics window 22, there are multiple child windows that can, but not necessarily, further comprise the graphical user interface including a textual input window 24, a task window 26, a property input window 28, an entity tree window 30, a textual output window 32, as well as various toolbars 34 and drop-down menu bars 36. It is to be understood that all child windows, including the toolbars 34 and drop-down menu bars 36, comprising the graphical user interface of the present invention can be arranged in differing locations, differing order, or eliminated all together to change or increase a users graphics viewing area in graphics window 22. It is to be also understood that these additional child windows generally display controls and information that allow the user to control depiction of an image within the graphics window 22. The main graphics window 22 and various child windows that are described below are created using Windows NT™ operating system running in conjunction with the FEA rendering software.

### TEXTUAL INPUT WINDOW

Referring again to FIG. 2, a textual input window 24 is attached to the main graphics window 22 in a default location towards the bottom middle of the graphical user interface.

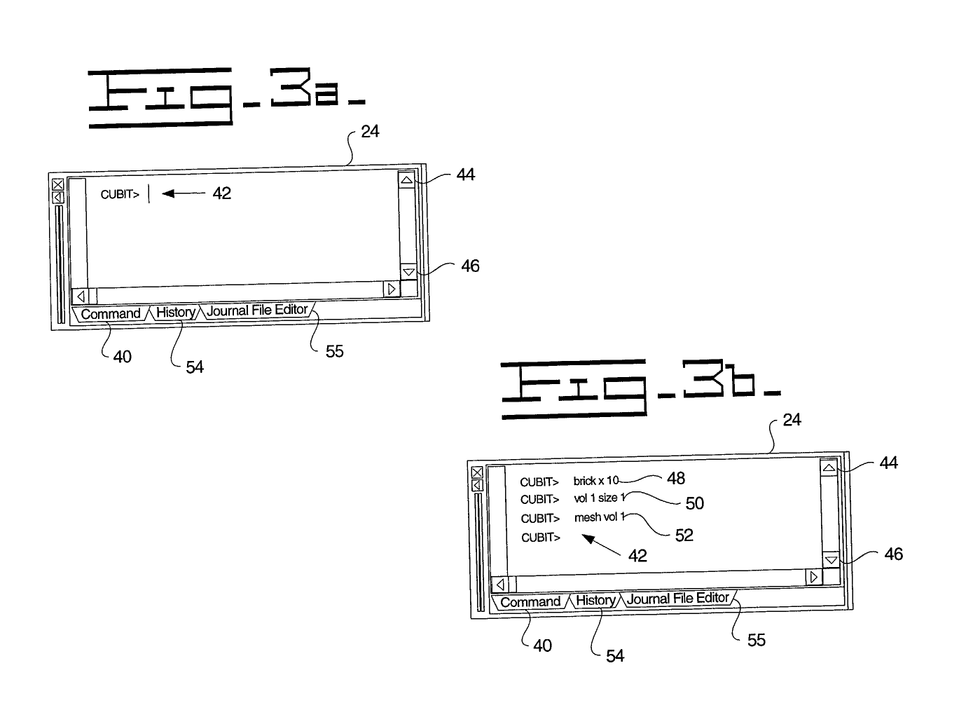

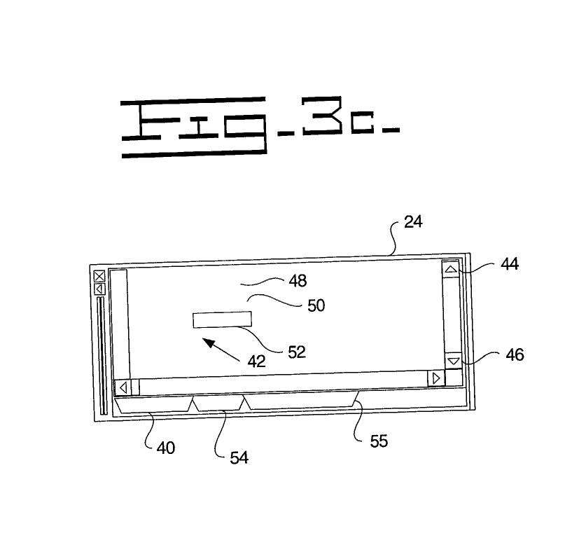

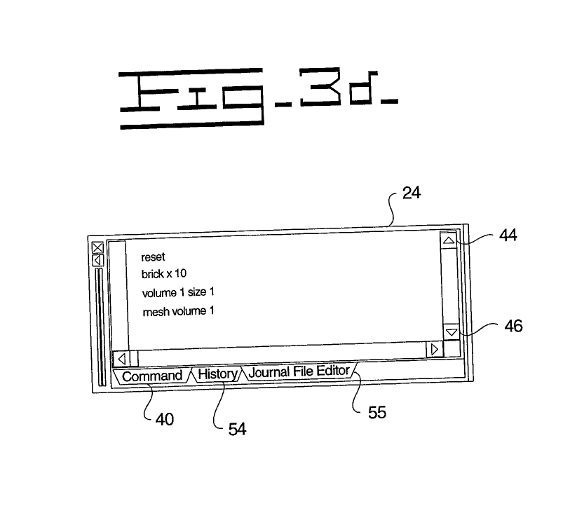

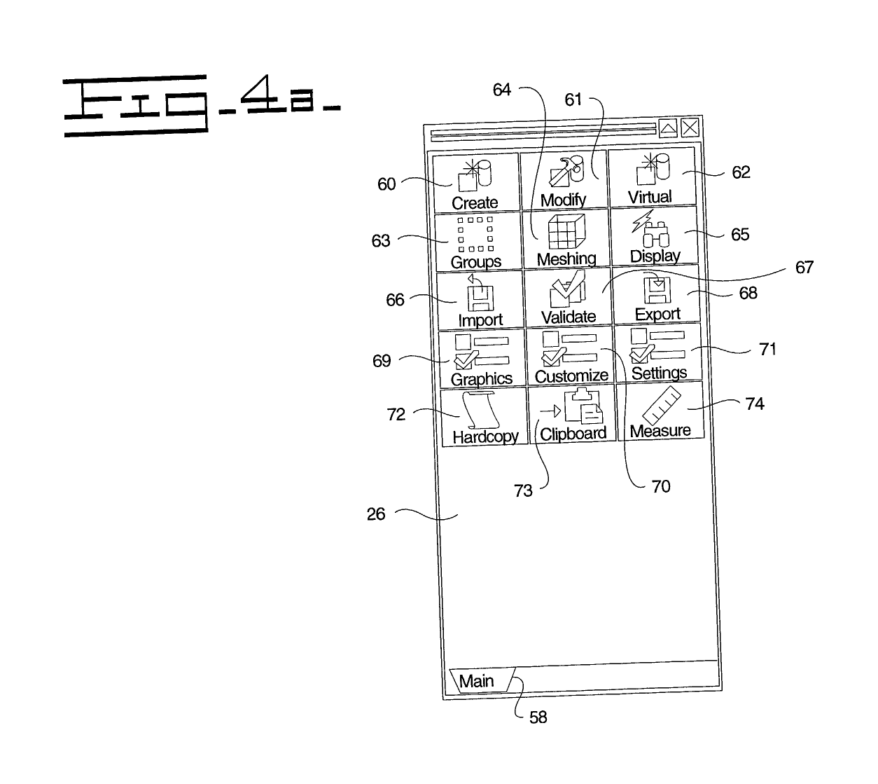

The textual input window 24 provides a method for displaying direct keyboard entry of commands. As individually seen in FIG. 3A, there is a tab-based menuing system including, in this example, three exemplary tab identifiers (40, 54, and 55), each associated with a particular interface element, available within the textual input window 24 for ease of viewing and functionality. Preferable, a user may, upon selection of any tab identifier, alternate between various interface elements within textual input window 24.

Under the “Command” tab identifier 40 a command prompt 42 is present for entry by the user of all textual commands for an FEA application. Preferable, all commands can be manually and textually entered from command prompt 42 within textual input window 24.

Also displayed in textual input window 24, within the interface element associated with “Command” tab identifier 40 is previously executed commands, as shown in FIG. 3B. These previously executed commands are shown, for example, in prior command line 48 near the top of the textual input window 24. In prior command line 48 the user previously entered “brick×10”, in another prior command line 50 “vol 1 size 1”, and in yet another prior command line 52 “mesh vol 1.” If desired, all prior commands can be seen by selecting the enabled up-arrow button 44 or down-arrow button 46.

Utilizing these previously entered commands, the textual input window 24 permits a user to select a previous command, such as that on command line 52 in FIG. 3C, and drag-and-drop it on command prompt 42 to execute such command. Similarly, a user may remain on command line 42 and select the up and down arrows on keyboard 14 to place previously executed commands directly into command prompt 42.

Also, in the preferred embodiment, key command words are, but not necessarily, color coded according to their significance for distinguishing between geometry entities and mesh entities and their corresponding commands. Geometry entities typically comprise a computer-aided solid model, while mesh entities comprise the finite element model that the solid model was discretized into. For example, the commands for geometry entities such as “body,” “volume,” “surface,” “curve,” and “vertex,” for example, can appear in a first color, such as blue, whereas commands for mesh entities such as “hex,” “face,” “edge,” “node,” “tet,” and “tri,” for example, can appear in a second color, such as magenta.

An alternative to viewing previously executed commands entered under “Command” tab identifier 40 is by selecting the “History” tab identifier 54, as shown in FIG. 3D. “History” tab identifier 54 allows for easy viewing and play back of previously executed commands. However, under “History” tab identifier 54, previously executed commands are shown by themselves, without prompts, and without restriction or limitation of prior entry order. Accordingly, “History” tab identifier 54 allows for quick retrieval and re-execution of commonly used, yet previously executed commands. A user may re-execute a previously executed command within a particular history line by simply selecting that specific previously executed command. Although textual input window 24 is considered to be an important tool, it is to be understood that memorization and manual keyboard entry of every available textual FEA command into textual input window 24 can be difficult and inefficient as well as time consuming for both novice and expert users. One manner by which the graphical user interface of the present invention overcomes this inefficiency is by generating FEA application commands for the user as the user interacts with the graphical user interface.

The third tab identifier within the textual input window 24 is “Journal File Editor” tab identifier 55 which primarily enables the option to import text journal files such as ascii, for example, containing a particular set(s) of FEA commands. After importation, these commands can be edited, manipulated, and executed as desired by a user.

### TASK WINDOW

Referring back to FIG. 2, a task window 26 is attached to the main graphics window 22 in a default location towards the top left of the graphical user interface.

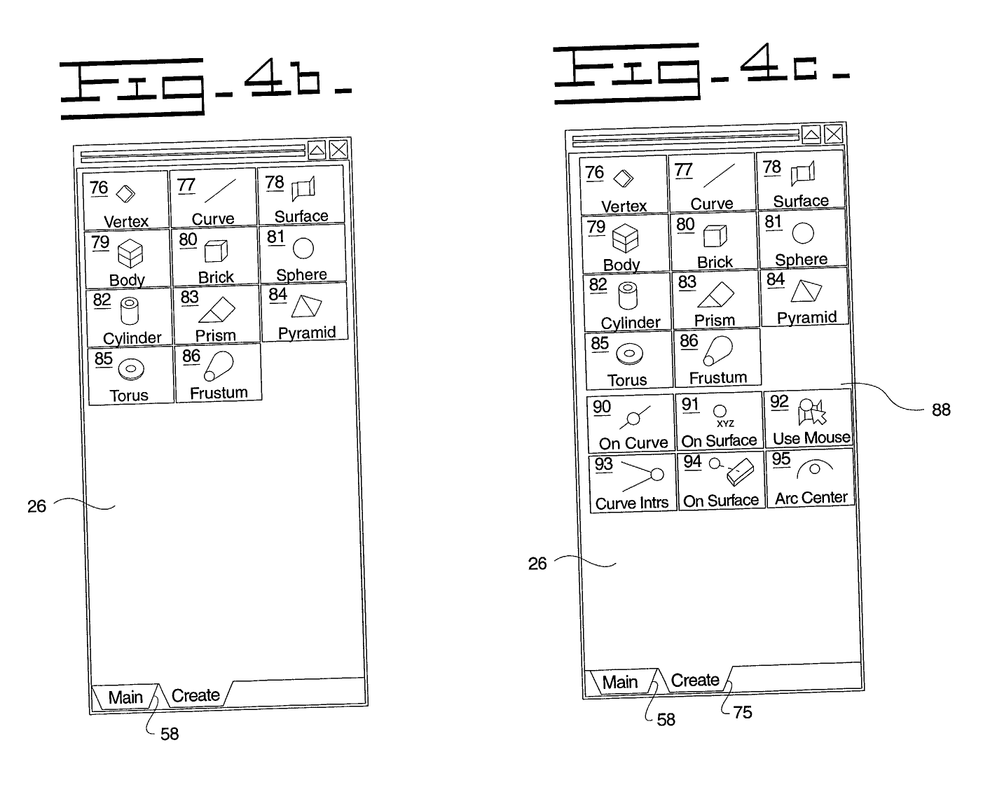

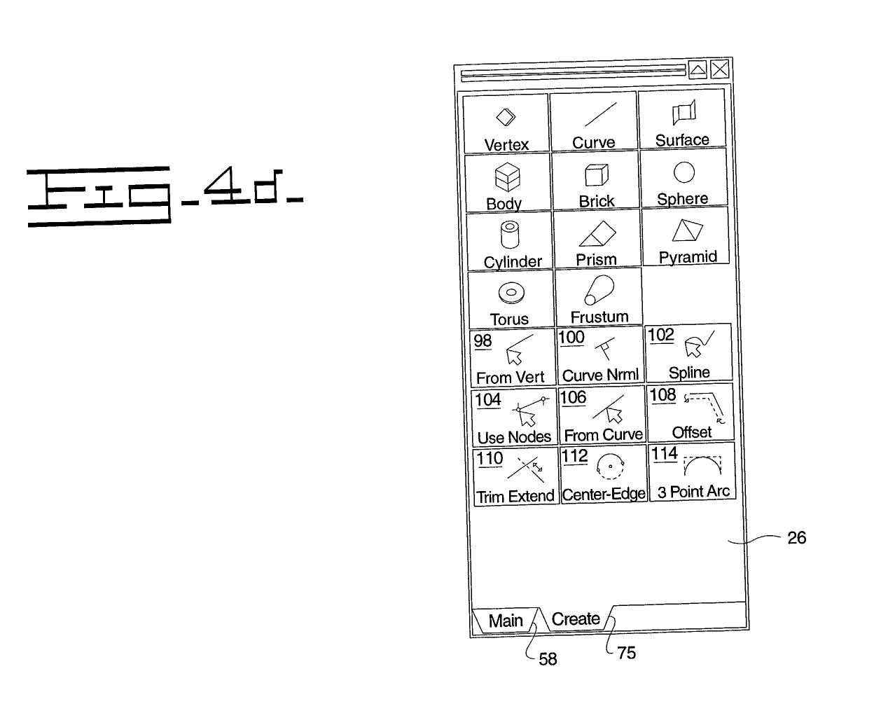

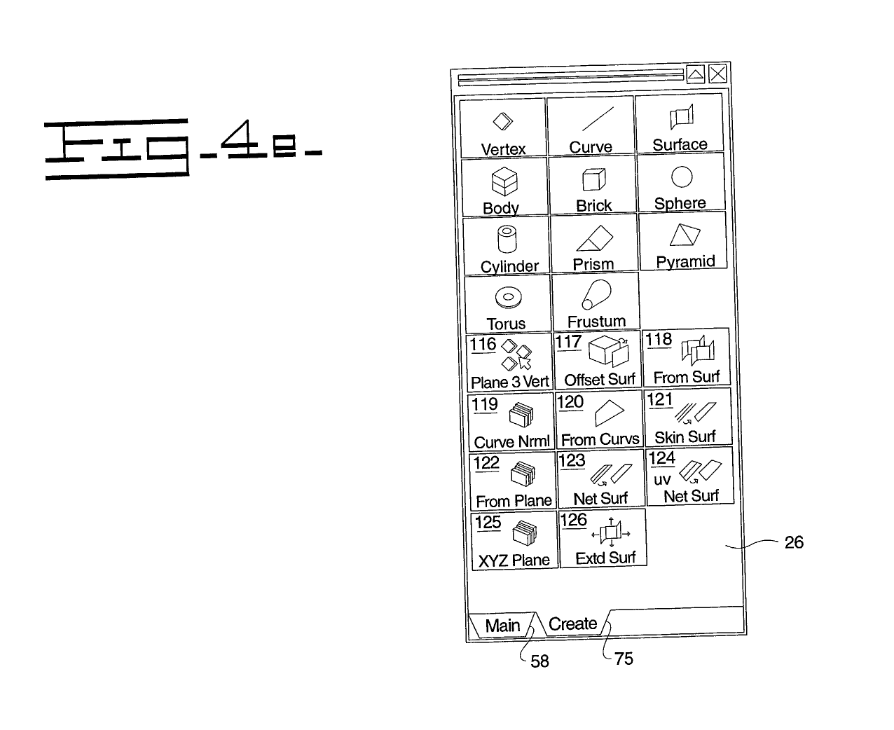

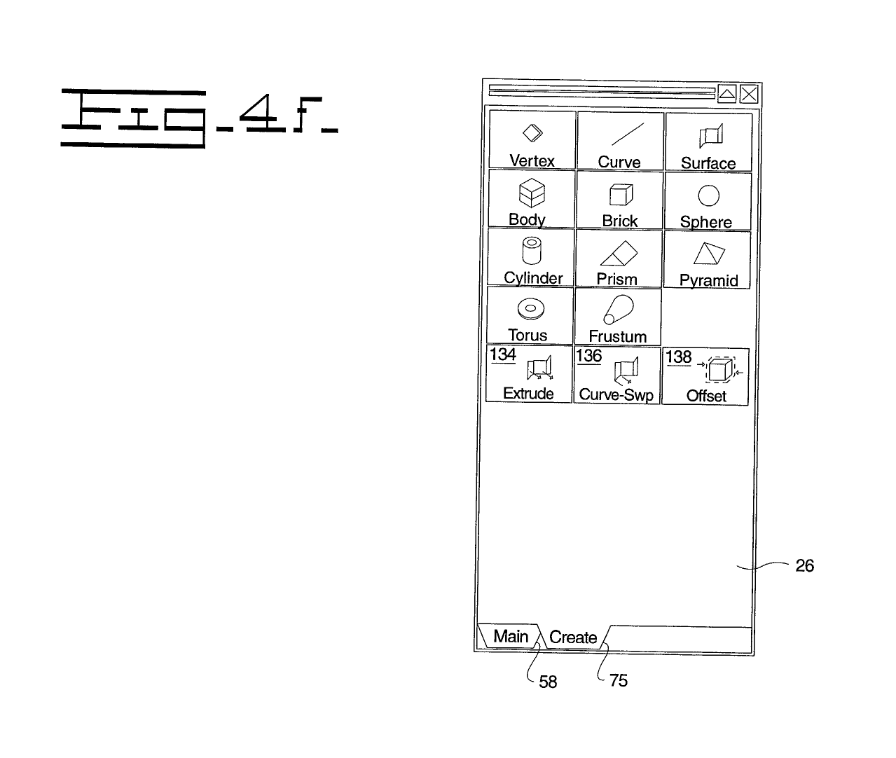

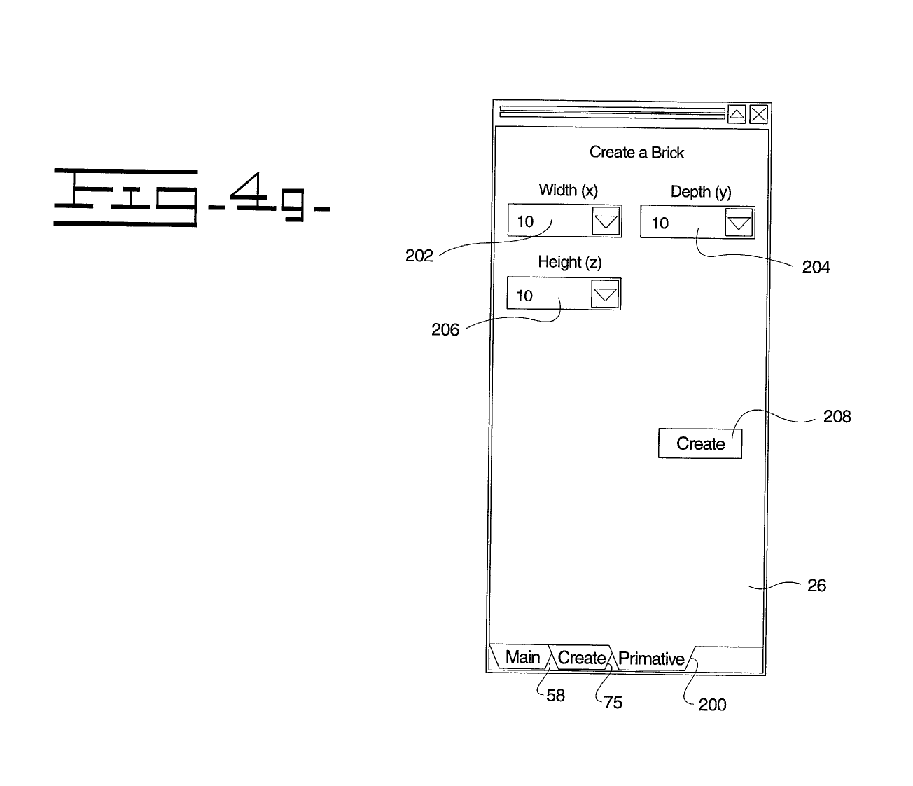

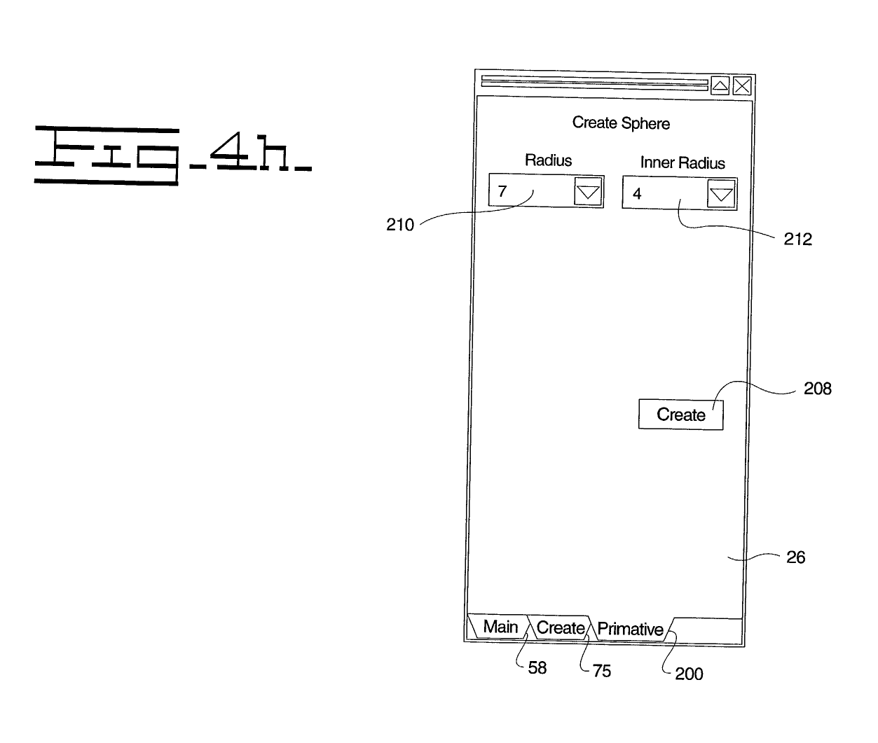

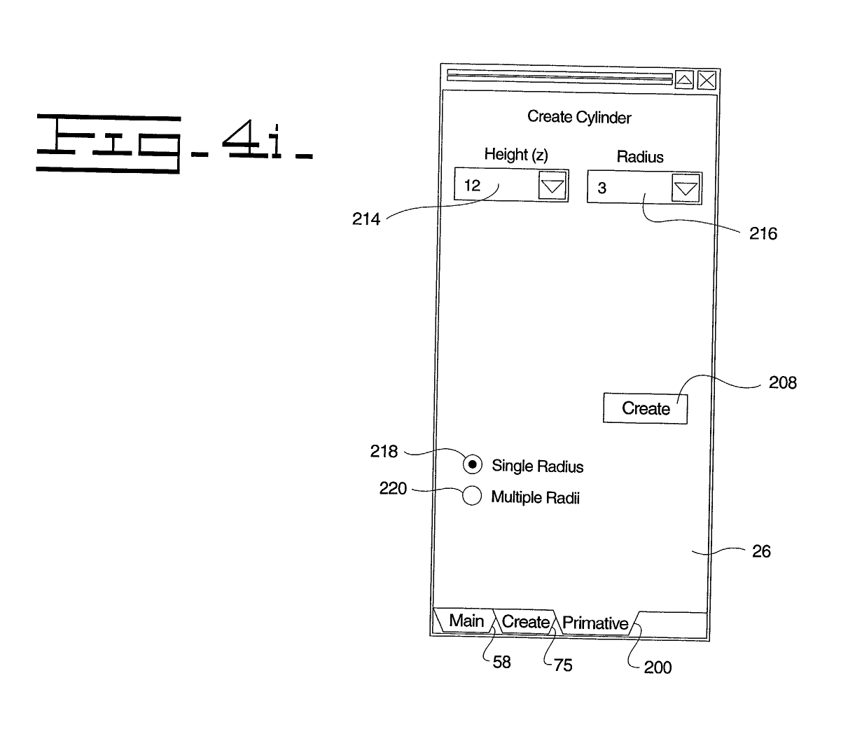

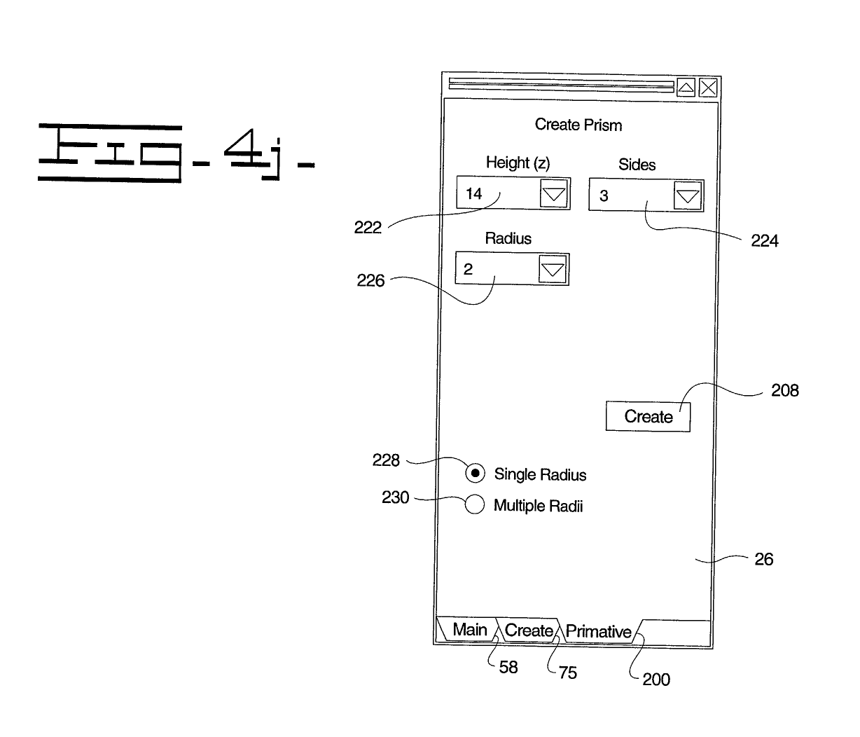

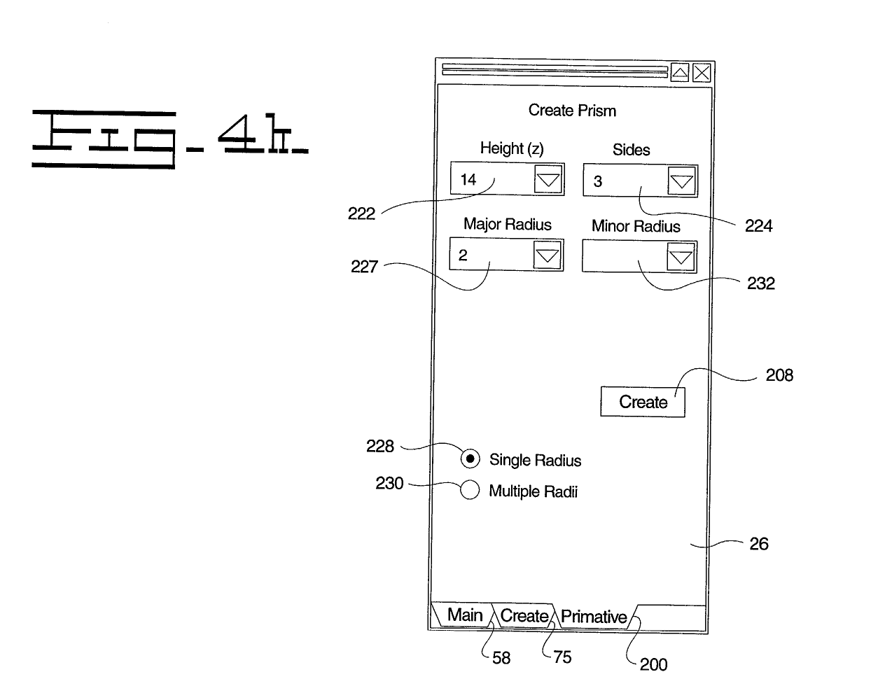

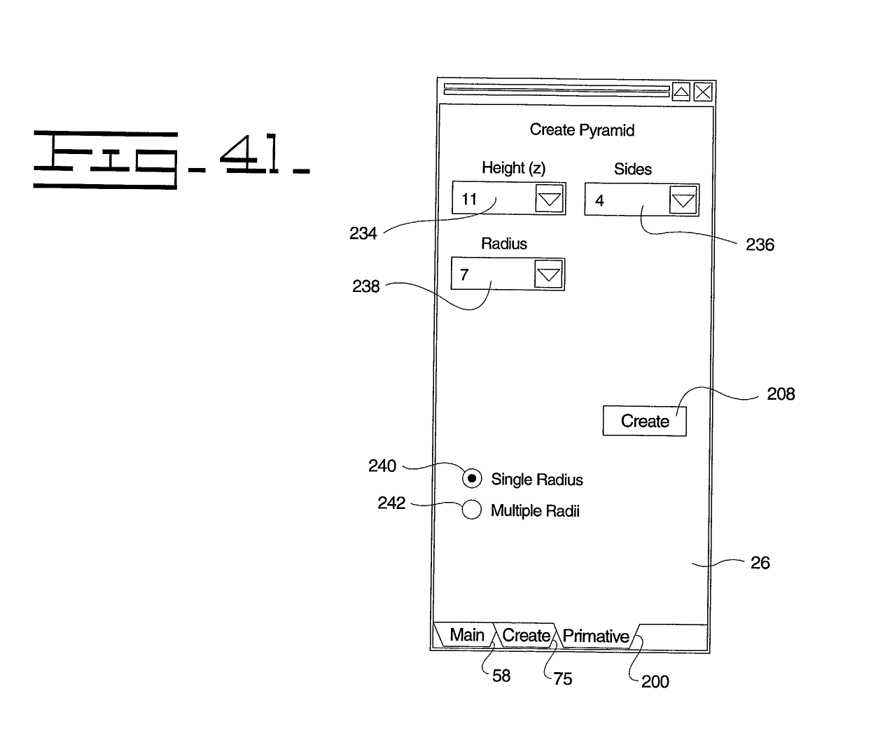

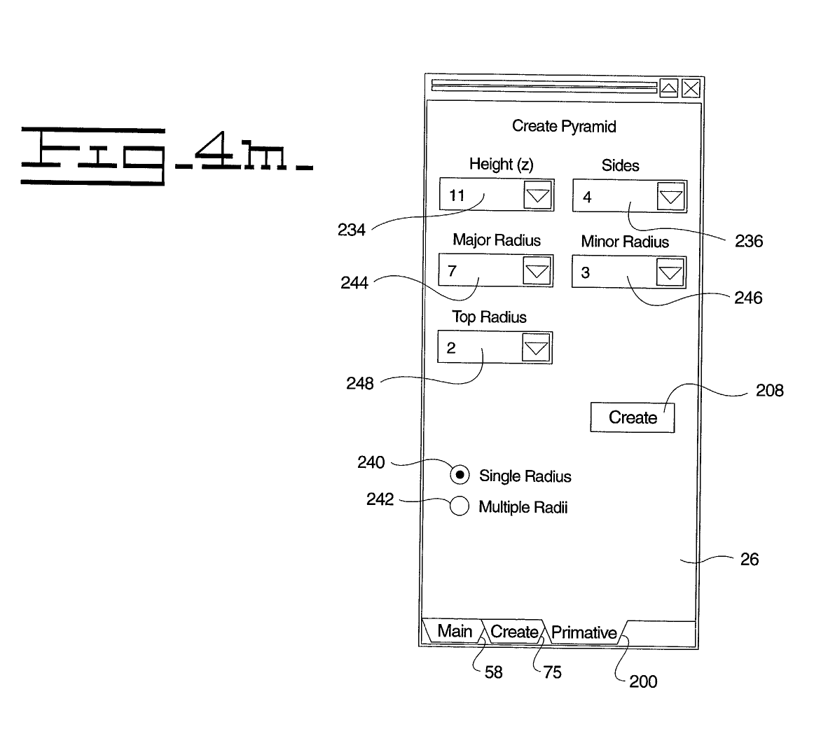

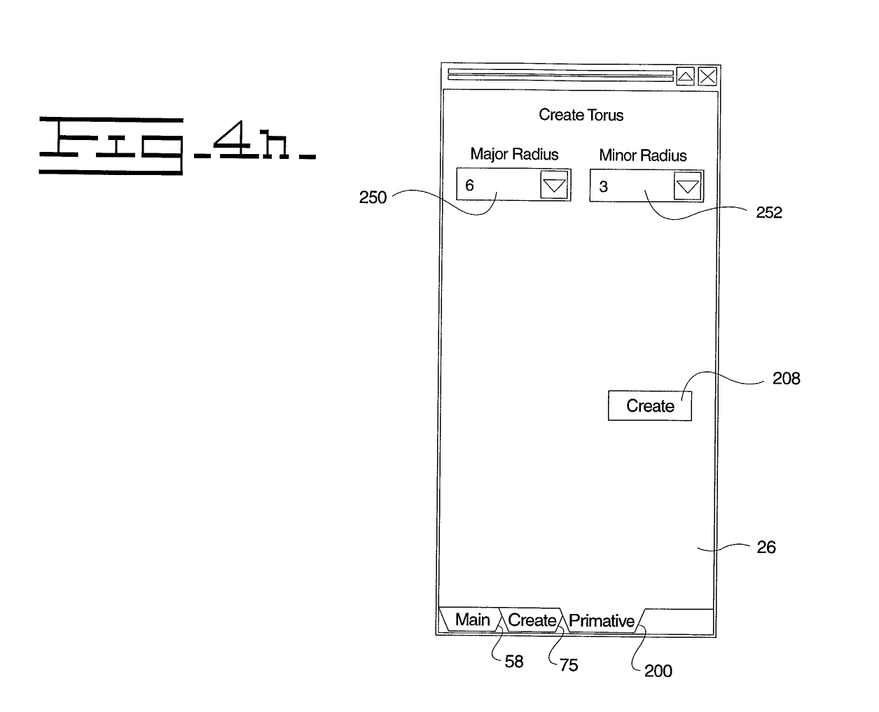

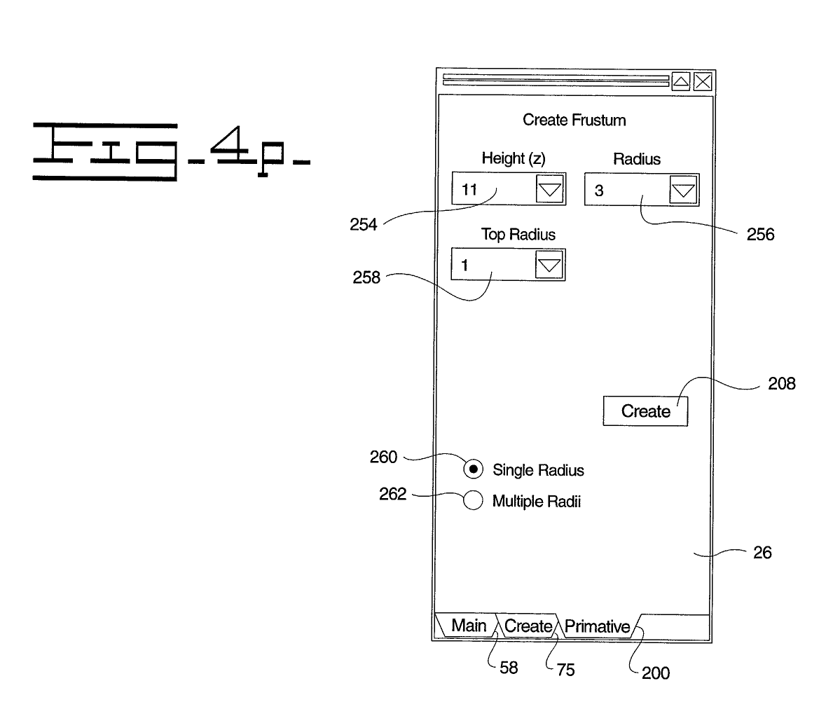

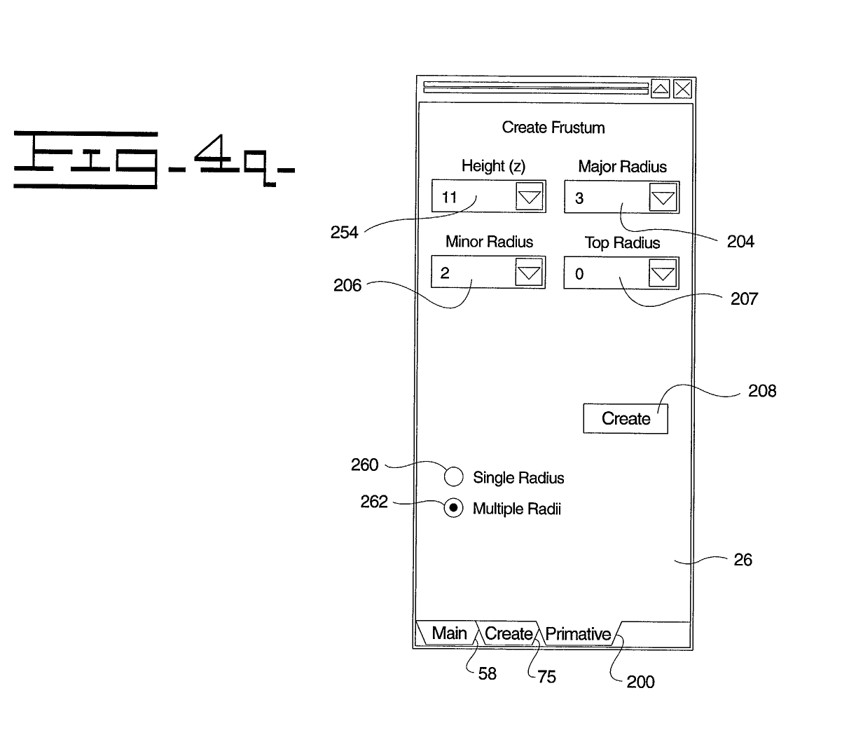

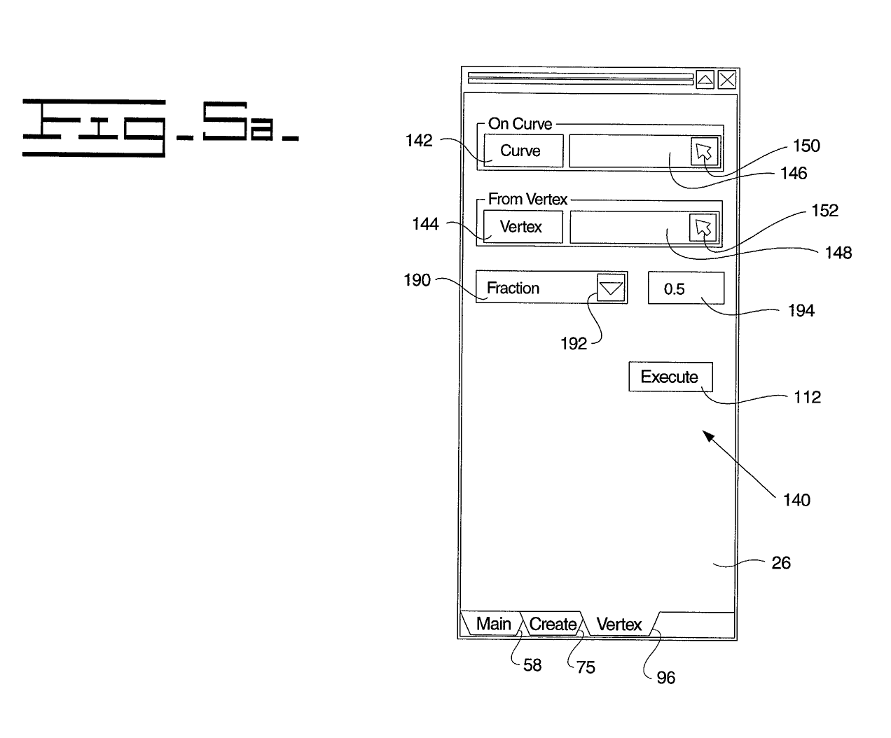

As individually shown in FIG. 4A, the task window 26 preferably provides accessibility to a majority of all commands and functions related to a FEA application. The task window 26 is operated by selecting readily available iconic buttons which are extremely easy for a user to navigate. Generally, upon selection of an iconic button, a new interface element will appear in task window 26 providing more specific choices of commands within each category. This selection process and description of each button under “Main” tab identifier 58, within task window 26, and its functionality will now be explained in more detail.

As individually seen in FIG. 4A task window 26, with its associated interface element, displays a set of iconic buttons that control particular FEA tasks. Generally, these buttons offer the user the ability to perform all necessary tasks for geometry manipulation and meshing of entities within graphics window 22. In accordance with a presently preferred embodiment of the invention there are several different buttons 60-74 under “Main” tab identifier 58 as shown in FIG. 4A. Specifically, these buttons 60-74 consist of the following:

“Create” button 60 allows creation of new entities such as vertices, curves, surfaces, and bodies, for example.

“Modify” button 61 is for editing existing geometry by webcutting (partitioning) imprinting, cleaning (removing unneeded geometry/topology), combining, boolean operations, healing, positioning, scaling, deleting, separating, splitting, copying, merging, and tweaking, for example.

“Virtual” button 62 allows for creation of virtual entities such as virtual curves and composite surfaces, for example.

“Group” button 63 is for grouping items by either adding to groups or propagating groups, for example.

“Meshing” button 64 allows for creation, deletion, and modification of meshing, morphing, and interval matching, for example.

“Display” button 65 is for displaying entities by drawing, changing colors, or setting visibility, for example.

“Import” button 66 allows for importation of files such as ACIS (.sat, sab), IGES, STEP, universal mesh files (.unv) and genesis mesh files, for example.

“Validate” button 67 is for validating geometry by checking for bad geometry, for example.

“Export” button 68 allows for exportation of files such as ACIS (.sat, sab), IGES, STEP, I-DEAS universal file format (.unv), PATRAN neutral file format (.pat), and genesis mesh files, for example.

“Graphics” button 69 is for setting the graphic window 22 defaults, for example.

“Customize” button 70 allows for customization of commands within child windows, for example.

“Settings” button 71 is for setting the save/restore attributes, for example.

“Hardcopy” button 72 allows for printing of the graphics window 22, for example.

“Clipboard” button 73 is for copying the graphics window 22 to the user's clipboard for pasting into other applications, for example.

Finally, the interface element, within task window 26, that is associated with “Main” tab identifier 58 includes “Measure” button 74 for measurement between entities as well as the ability to find small curves/surfaces and overlapping surfaces, for example.

Generally, by selecting a specific button within the interface element associated with “Main” tab identifier 58, a different interface element with an associated tab identifier and additional suite of iconic buttons is presented for increased detailed control and ease of use. Preferable, a user may, by selecting any tab identifier, alternate between the various interface elements that occur within a child window. The following discussion of the task window 26 will proceed in the order of buttons, as discussed immediately above.

### A. Create

Upon selection of “Create” button 60 a second interface element, with a suite of buttons 76-86, associated with “Create” tab identifier 75, overlays the first interface element associated with “Main” tab identifier 58, as individually shown in FIG. 4B. Preferably, “Main” tab identifier 58 remains visible to the user despite its' associated interface element being overlapped by the interface element associated with “Create” tab identifier 75. This flexibility and ergonomic design allows a user, upon selection of any tab identifier, to alternate between various interface elements that occur within task window 26 for increased control and efficiency in operation of a FEA application.

Additionally, the suite of buttons 76-86 provide further control of finite element design and creation. In the preferred embodiment, the FEA application allows for at least two approaches to generating geometry. Preferably, the first approach is bottom-up creation and the second approach is primitive creation.

Bottom-up creation involves the ability to create geometry from a collection of lower order entities. This is generally accomplished by first creating vertices, connecting vertices with curves, and connecting curves into surfaces.

Existing geometry may be combined with new geometry to create higher order entities. For example, a new surface can be created using a combination of new curves and curves that already exist in the model. Preferably, several of the basic entities that can be generated using this bottom-up approach include vertices, curves, surfaces, and volumes which are accessible through “Vertex” button 76, “Curve” button 77, “Surface” button 78, and “Body” button 79, respectively.

Primitive creation involves the ability to create geometry from pre-defined templates of three-dimensional geometric shapes. Creation of specific instances of these shapes is accomplished by providing values to the parameters associated with the chosen primitive. Preferably, several of the primitives that can be created using the primitive creation approach include the brick, sphere, cylinder, pyramid, torus, and frustum which are accessible through “Brick” button 80, “Sphere” button 81, “Cylinder” button 82, “Prism” button 83, “Pyramid” button 84, “Torus” button 85, and “Frustum” button 86, respectively. It is to be understood that the present graphical user interface provides several options for generating entities using the primitive approach as well as the bottom-up approach and are described below in further detail.

Again, after selection of the “Create” button 60 and selection of “Vertex” button 76, which allows for creation of vertices, further detailed options for generating vertices via buttons 90-95 are provided, as individually shown in FIG. 4C. More particularly, “On Curve” button 90 allows for creation of vertices on an existing curve at a distance from an end vertex; “On Surface” button 91 is for creation of vertices at a specified x-y-z location on a curve or surface; “Use Mouse” button 92 allows for creation of vertices on an existing curve or surface using the mouse; “Curve Intrs” button 93 is for creation of vertices at the intersection of two curves; “On Surface” button 94 allows for creation of vertices at the closest point on a surface to another vertex; and “Arc Center” button 95 is for creation of vertices at the center of an arc. Upon selection of one of these buttons 90-95, a new interface element, with an associated tab identifier, appears within task window 26 and will be explained in more detail below.

A “Curve” button 77, as shown in FIG. 4B, is for the creation of curves by specifying the bounding lower-order topology (i.e., vertices) and the geometry (shape) of a curve (along with any parameters necessary for that geometry). Upon selection of “Curve” button 77, detailed options for generating curves appear via buttons 98-114, as individually shown in FIG. 4D. More particularly, “From Vert” button 98 allows for creation of curves from two vertices; “Curve Nrml” button 100 is for creation of curves through a vertex relative to another curve; “Spline” button 102 allows for creation of curves through multiple vertices to generate a spline; “Use Nodes” button 104 is for creation of curves using nodes; “From-Curve” button 106 allows for creation of curves from another curve; “Offset” button 108 is for creation of curves offset from another curve; “Trim Extend” button 110 allows for creation of curves by trimming or extending a curve; “Center Edge” button 112 is for creation of curves from a midpoint to form an arc or circle; and “3 Point Arc” button 114 allows for creation of curves from three vertices to form an arc or circle. As with the buttons 90-95 associated with “Vertex” button 76, upon selection of one of the buttons 98-114 associated with “Curve” button 77, a new interface element, with an associated tab identifier, appears within task window 26 and will be explained in more detail below.

A “Surface” button 78, as shown in FIG. 4B, is for creation of surfaces by fitting an analytic or spline surface over a set of bounding curves. Upon selection of “Surface” button 78, a number of methods for generating surfaces are provided via buttons 116-126, as individually shown in FIG. 4E. More particularly, a user may generate a surface: from three vectors via “Plane 3 Ver” button 116; offset from another surface via “Offset Surf” button 117; by copying from another surface via “From Surf” button 118; through a curve relative to another surface via “Curve Nrml” button 119; bounded by an existing set of curves via “From Curvs” button 120; by skinning via “Skin Surf” button 121; from a specified plane via “From Plane” button 122; from a three-dimenstion mapped mesh via “Net Surf” button 123; from a set of U-V curves via “UV Net Surf” button 124; normal to a principal axis via “XYZ Plane” button 125; and finally extended from another surface via “Extd Surf” button 126. As with the buttons associated with “Vertex” button 76 and “Curve” button 77, upon selection of one of the buttons 116-126 associated with “Surface” button 78, a new interface element, with an associated tab identifier, appears within task window 26 and will be explained in more detail below.

“Body” button 79 within task window 26, as shown in FIG. 4B, is for creation of volumes from surfaces by sweeping a single surface into a three-dimensional solid or by offsetting an existing volume. Upon selection of “Body” button 79, a number of methods for generating volumes are provided via buttons 134-138, as individually shown in FIG. 4F. More particularly, “Extrude” button 134 allows for creation of volumes by extruding a surface; “Curve-Swp” button 136 is for creation of volumes by sweeping a surface along a curve; and “Offset” button 138 allows for creation of volumes as an offset from another volume. As with the buttons associated with “Vertex” button 76, “Curve” button 77, and “Surface” button 78, upon selection of one of the buttons 134-138 associated with “Body” button 79, a new interface element, with an associated tab identifier, appears within task window 26 and will now be explained in more detail.

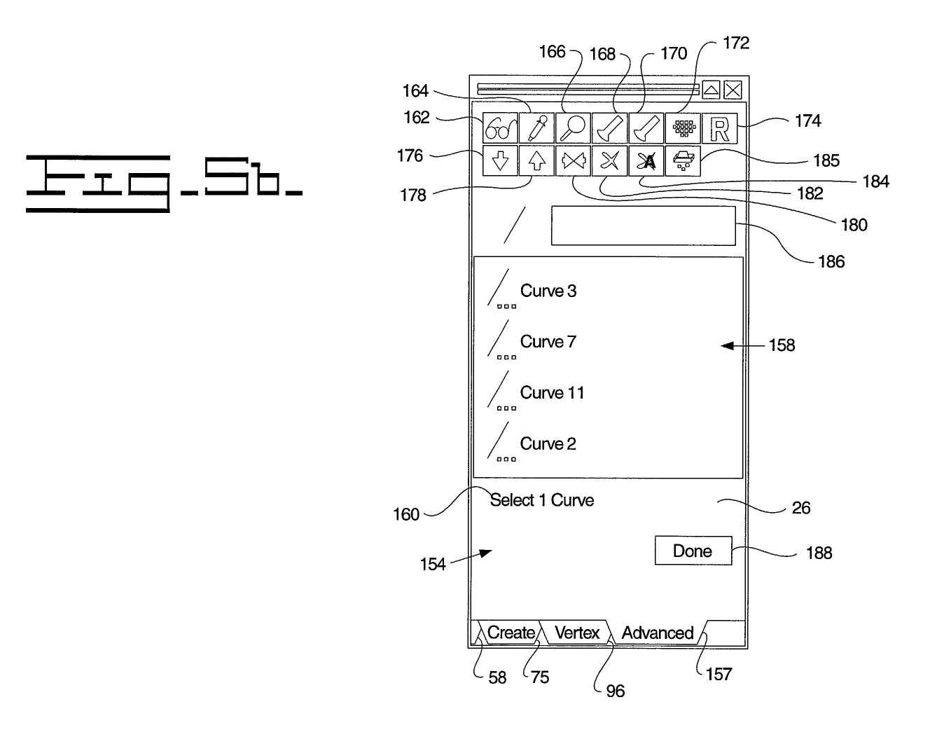

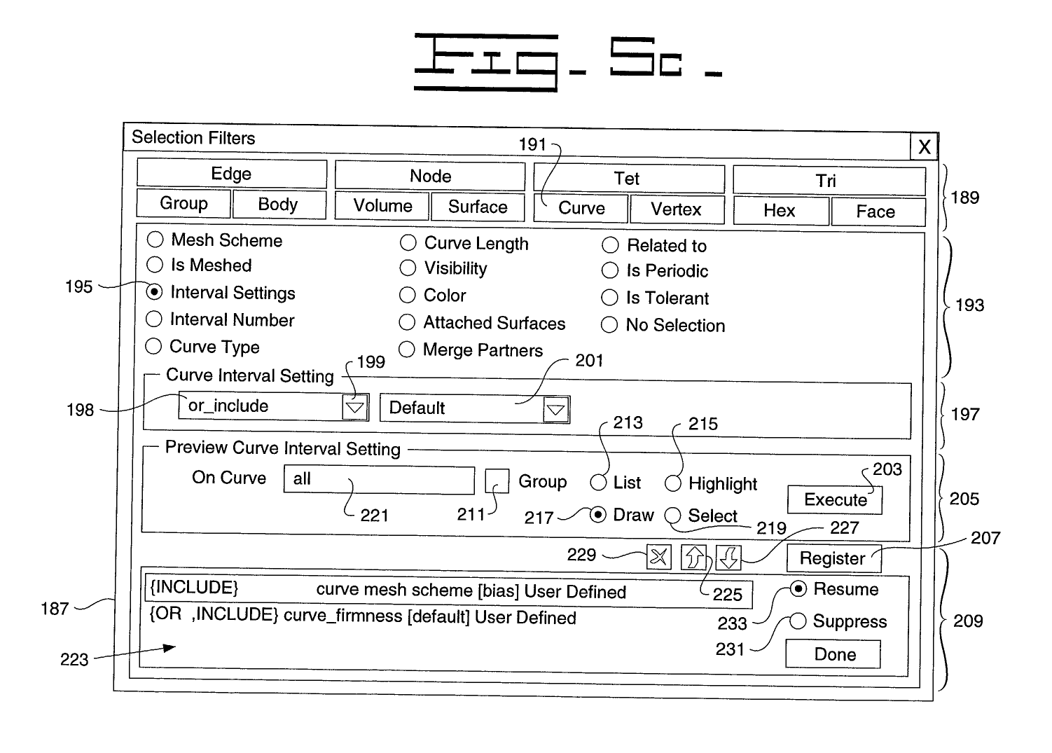

After selection of any detailed buttons 90-95, 98-114, 116-126, and/or 134-138 associated with “Vertex” button 76, “Curve” button 77, “Surface” button 78, and “Body” button 79, respectively, a new interface element, in this case command dialogue interface 140, with an associated tab identifier, appears within task window 26 as shown in FIG. 5A, for example, for further specification of entity attributes. More specifically, in the example shown in FIG. 5A, the user has selected the “On Curve” button 90, for example, where such selection results in command dialogue interface 140 being associated with “Vertex” tab identifier 96 in the task window 26. This interface element with “Vertex” tab identifier 96 now directly overlies the interface element associated with “Create” tab identifier 75 as well as the interface element associated with “Main” tab identifier 58. Preferably, as stated before, “Main” tab identifier 58 and “Create” tab identifier 75 remain visible to the user despite their associated interface elements being overlapped by the interface element associated, in this instance, with “Vertex” tab identifier 96. It is also to be understood that in this particular example, the name of tab identifier 96 is dependent upon the higher level entity selected. For example, if the user had selected “Curve” button 77, the tab identifier 96 associated with command dialogue 140, would be instead labeled “Curve” rather than “Vertex.”

In FIG. 5A, the type-selection buttons, labeled “Curve” button 142 and “Vertex” button 144 in this example, within command dialogue interface 140, allow entity identification (“ID”) and proximities to be entered into type-selection fields 146 and 148. It is to be understood that a type-selection button(s) shows the entity type(s) (e.g., Curve, Vertex, Body, Surface) that is required for the particular command selected and that is currently available for picking from graphics window 22 or typing using keyboard 14 or dragging and dropping from other child windows using mouse 16, for example.

An additional method of placing the proper entity ID into a type-selection field (e.g., fields 146 or 148) within command dialogue interface 140 includes arrow buttons 114 and 116 which provide access to additional selection tools. Selection of either arrow button 150 or 152, for example, will bring up a new interface element, in this instance, advanced selection dialogue interface 154, which is associated with “Advanced” tab identifier 156, as shown in FIG. 5B. The advanced selection dialogue interface 154 is generally used whenever a geometry or mesh entity is required in a FEA command and selection of that entity in graphics window 22 is particularly difficult or the user wants additional options while selecting. As shown in FIG. 5B, a current list of entities that may be used for a desired command are automatically displayed for the user in list box 158. Below list box 158 is a required-entity field 160 indicating the number and type of entities required for the current command. For instance, in this example in FIG. 5B, the selection of only one curve is required to complete the desired command.

Entities can also be added, removed, and manipulated using various tools in the toolbar at the top of the advanced selection dialogue interface 154 represented by two rows of iconic buttons. The following is an exemplary list of these buttons shown in FIG. 5B with their related functionality: highlight-selection button 162 allows an entity(ies) selected by the user in the list box 158 to become highlighted in graphics window 22 for quick and easy identification; draw-selection button 164 provides entities selected by the user in the list box 158 to be illustrated by themselves in graphics window 22, again, for quick and easy identification; zoom-selection button 166 allows a user to zoom-in on a selected entity(ies); make-selection-visible button 168 allows a currently selected invisible entity to become visible and illustrated in the graphics window 22; make-selection-invisible button 170 conversely makes a currently selected visible entity invisible; select-all button 172 automatically selects all entities currently in list box 158; related-to-picking button 174 allows entities of the required type that are related to the selected entities in list box 158 to be used in the current desired command (e.g., selecting all the curves that are in a particular surface); add-selections button 176 allows entities selected from the graphics window 22 to be added to list box 158; remove-selections button 178 allows entities that are in list box 158 to be removed upon selection of such entities in graphics window 22; intersect-selection button 180 performs intersection of entities that are selected from graphics window 22 with those entities selected in list box 158; remove-entity button 182 allows selected entities from list box 158 to be removed from the list; remove-all button 184 allows removal of all entities from list box 158; and filter dialog button 185 provides access to filter picking dialog interface window 187 that allows for entity filtering to quickly select desired entities needed and to parse out those that match (or do not match) certain entity characteristics.

### A. Create

Upon selection of filter dialog button 185, filter picking dialog interface window 187 is outputted from task window 26 yet appearing separate of task window 26, as individually shown in FIG. 5C. Again, filter picking dialog interface window 187 provides an interface for entity filtering to quickly select the entities needed to parse out those entities that match (or do not match) certain entity characteristics. As shown in FIG. 5C, to filter entities, the user first selects the type of entity to be filtered via tabs, with associated interface elements, indicated generally by numeral 189. Upon selection of one tab, for instance “Curve” tab 191, a new interface element appears with the criteria and options available for the particular entity type, in this case curves. The criteria for filtering is chosen from the filter-type section generally indicated by numeral 193. In this example, the user has chosen “Interval Settings” radio button 195. Based on the filter criteria type selected, additional information for defining the filter criteria is determined in the filter-criteria section generally indicated by numeral 197. In this section, filter-criteria field 198 allows selection of preferably four options, via arrow button 199, comprising: “or_include” (shown) which returns all entities matching the input and performs the specified action only on the entities returned from the filter (i.e., draw only the filtered entities in graphics window 22); “and_include” which returns all entities matching the input and performs the specified action on the entities returned from the filer in addition to those already filtered (i.e., draw filtered entities in additional to those already displayed in graphics window 22); “or_exclude” which returns all entities other than the result of the filter and performs the specified action only on the entities returned from the filter (i.e., draw only the excluded filtered entities in graphics window 22); and “and_exclude” which returns all entities other than the result of the filter and performs the specified action on entities returned from the filter in additional to other entities already filtered (i.e., draw excluded filtered entities in addition to those already displayed in graphics window 22). Other criteria details related to the specific selected filter type may also be specified in field 201 within section 197.

Once the filter criteria type and details have been specified, the filter can either be executed, via “Execute” button 203 in the section generally indicated by numeral 205, or registered via “Register” button 207 in the section generally indicated by numeral 209.

Selecting “Execute” button 203 causes the specified action to be executed on the entities returned from the filter. The actions that preferably can be performed on the filtered entities include: grouping the entities matching the filter criteria via “Group” check box 211; listing information about the entities matching the filter criteria in textual output window 32 via “List” radio button 213; draw in graphics window 22 the entities matching the filter criteria via “Draw” radio button 215; highlight the entities in graphics window 22 matching the filter criteria via “Highlight” radio button 217; and select the entities in graphics window 22 matching the filter criteria via “Select” radio button 219.

Also specified in section 205, within FIG. 5C, is field 221 which indicates the initial set of entities on which the filter will be performed. In most cases “all” can be used which indicates that all entities of the specified type will be interrogated for the filter criteria. The user can also enter a subset of the entities with which to start with by specifying a range of entity name/IDs.

On the other hand, selecting “Register” button 207 in section 209 allows a filter to be registered for later use. When a filter is registered, subsequent selection operations in graphics window 22 will be limited to those that meet the filter criteria specified. Any number of filters may be registered simultaneously and list box 223 displays a list of the currently registered filters, if any. To register a filter a user selects the required data from filter-type section 193 and filter-criteria section 197 and selects “Register” button 207. The syntax for the new filter will then appear in register list box 223.

Priority of filtering is based on the order that filters are displayed in register list box 223 and can be changed by selected a filter in register list box 223 and using arrow buttons 225 and 227. A registered filter can also be deleted by selecting a filter in register list box 223 and selecting the delete button 229.

Additionally, although a registered filter is in effect until it is explicitly deleted via button 229, a filter can be suppressed or deactivated while still remaining a registered filter by selecting “Suppress” radio button 231 and can be reactivated to resume being an active registered filter by selecting “Resume” radio button 233. Upon completion of utilization of filter picking dialogue interface window 187, selecting “Done” button 235 closes window 187 but, as stated above, all registered filters remain in effect even when filter picking dialogue interface window 187 in not active.

Referring back to advanced selection dialogue interface 154, and again to FIG. 5B, when an entity(ies) is ultimately selected, that entity(ies) will appear in field 186 and the user may select “Done” button 188 to put that selection into a type-selection field (e.g., type-selection fields 146 or 148) as shown in FIG. 5A.

Referring back to command dialogue interface 140 and again to FIG. 5A, field 190 provides the user with the opportunity to further define parameters of a command, in this example for locations along a curve from a vertex, for instance. A nonlimiting example of a location-along-curve option for parameter selection within field 190 is “Fraction” (e.g., 0.25 mm. gaps between vertices on a curve).

Once a selection is made using arrow button 192, such as “Fraction” as shown in FIG. 5A, the user must make an entry into field 194 which corresponds to the value associated with the selected parameter, such as “0.5” as shown in FIG. 5A. Once all fields within the command dialogue interface 140 are satisfied, the “Execute” button 196 becomes enabled in order to execute the current command.

Referring back again to FIG. 4B, task window 26 further includes within “Create” tab identifier 75, “Brick” button 80 for creation of rectangular parallelepipeds or cubical bricks. Upon selection of “Brick” button 80, instead of additional buttons appearing, a new “Create Brick” interface element is displayed within “Primitive” tab identifier 200, as individually shown in FIG. 4G. A cubical brick is created by specifying in fields 202, 204, and 206 the width or x dimension, depth or y dimension, and/or height or z dimension, respectively.

Upon entry of at least one dimension, a user can select the “Create” button 208 for generation of a cubical brick in graphics window 22.

“Sphere” button 81, as shown in FIG. 4B, is for creation of a simple sphere, or an annular sphere. Similar to “Brick” button 80, upon selection of “Sphere” button 81 a new “Create Sphere” interface element is displayed within “Primitive” tab identifier 200, as individually shown in FIG. 4H. A solid sphere is created by specifying a radius in field 210. Alternatively, a hollow sphere is created by specifying both an outer radius in field 210 as well as an inner radius in field 212. Upon entry of the appropriate entity attributes, a user can select the “Create” button 208 for generation of a sphere in graphics window 22.

“Cylinder” button 82, as shown in FIG. 4B, is for creation of a cylinder which is a constant radius tube with right circular ends. Similar to “Brick” button 80 and “Sphere” button 81, upon selection of the “Cylinder” button 82 a new “Create Cylinder” interface element is displayed in task window 26 within “Primitive” tab identifier 200, as individually shown in FIG. 4I. A cylinder is created by specifying the height or z dimension and the radius in fields 214 and 216. A user may also choose between generating a cylinder of a single radius and a cylinder of multiple radii by selecting either radio button 218 or 220, respectively. Upon entry of the appropriate cylinder attributes, a user can select the “Create” button 208 for generation of the desired cylinder in graphics window 22.

“Prism” button 83, as shown in FIG. 4B, is for creation of a prism which is an n-sided, constant radius tube with n-sided planar faces on the ends on the tube. Similar to “Brick” button 80, “Sphere” button 81, and “Cylinder” button 82, upon selection of “Prism” button 83 a new “Create Prism” interface element is displayed in task window 26 within “Primitive” tab identifier 200, as individually shown in FIGS. 4J and 4K. As shown in FIG. 4J, a prism is created by specifying the height, sides, radius, and number of radii in fields 222, 224, 226, and radio buttons 228 or 230, respectively. The radius selected by a user defines the circumradius of the n-sided polygon on its end caps. If multiple radii are selected via radio button 230, the screen as shown in FIG. 4K appears for entry of the major radius in field 227 and minor radii in field 132 for bounding the end caps of the prism by a circum-ellipse instead of a circumcircle. Upon entry of the appropriate prism attributes, a user can select the “Create” button 208 for generation of the desired prism in graphics window 22.

“Pyramid” button 84, as shown in FIG. 4B, is for creation of a pyramid which is a general n-sided prism. Similar to “Brick” button 80, “Sphere” button 81, “Cylinder” button 82, and “Prism” button 83, upon selection of “Pyramid” button 84 a new “Create Pyramid” interface element is displayed in task window 26 within “Primitive” tab identifier 200, as individually shown in FIGS. 4L and 4M. As shown in FIG. 4L, a pyramid is created by specifying the height, sides, radius, and number of radii in fields 234, 236, 238, and radio buttons 240 or 242, respectively. If multiple radii are selected via radio button 242 the screen as shown in FIG. 4M appears for entry of the major radius in field 244, minor radius in field 246, and top radius in field 248. Upon entry of the appropriate pyramid attributes, a user can select the “Create” button 150 for generation of the desired pyramid in graphics window 22.

“Torus” button 85, as shown in FIG. 4B, is for creation of a simple torus. Similar to “Brick” button 80, “Sphere” button 81, “Cylinder” button 82, “Prism” button 83, and “Pyramid” button 84, upon selection of “Torus” button 84 a new “Create Torus” interface element is displayed in task window 26 within “Primitive” tab identifier 200, as individually shown in FIG. 4N. A torus is thus created by specifying the major radius in field 250 and the minor radius in field 252. The major radius is the radius of the spine of the torus and the minor radius is the radius of the cross-section of the torus. Upon entry of the appropriate torus attributes, a user can select the “Create” button 208 for generation of the desired torus in graphics window 22.

Finally, the task window 26 includes within “Create” tab identifier 75, a “Frustum” button 86, as shown in FIG. 4B, allowing for the creation of a frustum. A frustum is a general elliptical right frustum that can also be thought of as a portion of a right elliptical cone. Similar to “Brick” button 80, “Sphere” button 81, “Cylinder” button 82, “Prism” button 83, “Pyramid” button 84, and “Torus” button 85, upon selection of “Frustum” button 86 a new “Create Frustum” interface element is displayed in task window 26 with “Primitive” tab identifier 200, as individually shown in FIGS. 4P and 4Q. As shown in FIG. 4P, a frustum is created by specifying the height, radius, top radius, and number of radii in fields 254, 256, 258, and radio buttons 260 or 262, respectively. If multiple radii are selected via radio button 262 the screen as shown in FIG. 4Q appears for entry of the major radius in field 264, minor radius in field 266, and top radius in field 268. The major radius defines the x-radius and the minor radius defines the y-radius whereas the top radius defines the x-radius at the top of the frustum. Upon entry of the appropriate frustum attributes, a user can select the “Create” button 208 for generation of the desired frustum in graphics window 22.

### B. Modify

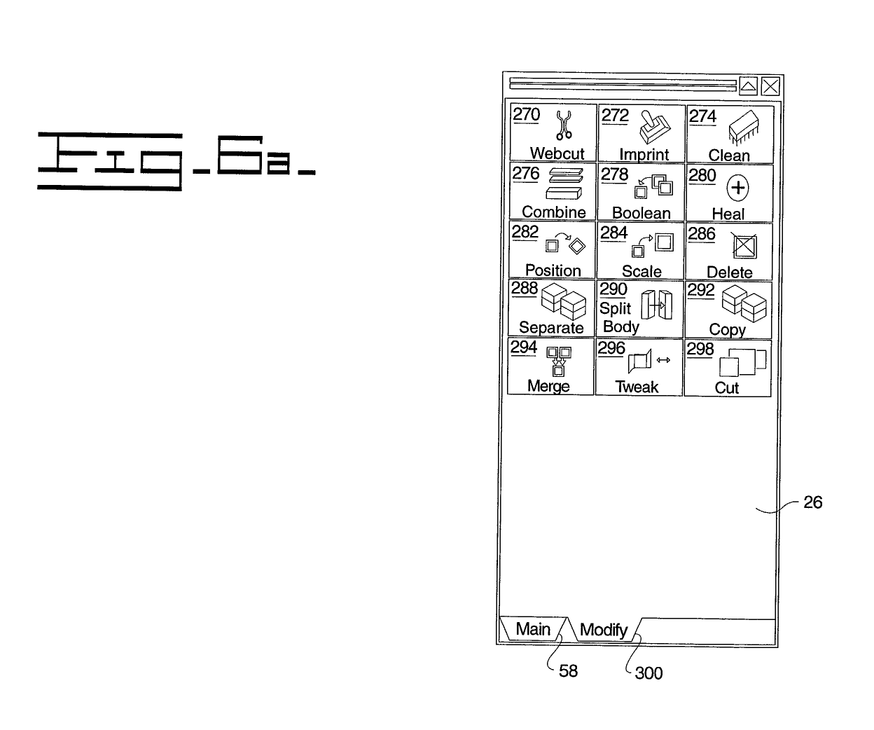

“Modify” button 61, as shown in FIG. 4A, is for editing entities previously created. Upon selection of “Modify” button 61 in FIG. 4A another different interface element, with a suite of buttons 270-296, associated with “Modify” tab identifier 300 is illustrated and directly overlies “Main” tab identifier 58, as shown in FIG. 6A. This suite of buttons 270-296 provide further control of shaping a finite element during the design and creation process. The following discussion will proceed in the numerical order of buttons presented within “Modify” tab identifier 300.

“Webcut” button 270, as shown in FIG. 6A, provides options that allow the act of cutting an existing body or bodies into two or more pieces through the use of some form of cutting tool. The two preferred types of cutting tools are surfaces (either pre-existing surfaces in the model or infinite or semi-infinite surfaces defined for webcutting), or pre-existing bodies. The primary purpose of web cutting is to make an existing model meshable (i.e., subdividing a complicated solid model into less complicated volumes) with meshing algorithms available in a FEA application.

“Imprint” button 272, as shown in FIG. 6A, provides allows the use of imprints to make merged coincident surfaces have like topology, for example. Specifically, to produce a non-manifold geometry model from a manifold geometry, coincident surfaces must be merged together. This merge can only take place if the surfaces to be merged have like topology and geometry.

Thus, while various parts of an assembly will typically have surfaces which coincide geometrically, an imprint is necessary to make the surfaces have like topology.

“Clean” button 274, as shown in FIG. 6A, provides options that improve an imported geometric model so that it can be adequately meshed and analyzed. Frequently, models imported from various FEA platforms either provide too much detail for mesh generation and analysis, or the geometric representation is deficient. The “Clean” button 274 provides options to remedy such situation.

“Combine” button 276, as shown in FIG. 6A, provides options that allow bottom-up geometry creation of bodies (e.g., combining a set of free surfaces into a manifold body).

“Boolean” button 278, as shown in FIG. 6A, provides options for operations that modify the geometry and/or the topology of existing solids. These operations usually replace the original bodies input to the boolean with new ones.

“Heal” button 280, as shown in FIG. 6A, provides options that detect and fixes models in a FEA's core solid modeling kemal, such as ACIS.

“Position” button 282, as shown in FIG. 6A, provides options for moving, rotating, or aligning bodies.

“Scale” button 284, as shown in FIG. 6A, provides options that resize a body by a constant scale and is scaled about its centroid.

“Delete” button 286, as shown in FIG. 6A, provides options for deleting bodies, surfaces, curves, or vertices.

“Separate” button 288, as shown in FIG. 6A, provides options to separate a body with multiple volumes into a multiple bodies with single volumes.

“Split Body” button 290, as shown in FIG. 6A, provides options that simplify meshing. Specifically, solids which contain periodic surfaces include cylinders, torii and spheres, for example. Splitting periodic surfaces simplify meshing and will result in curves and surfaces being added to a volume.

“Copy” button 292, as shown in FIG. 6A, provides options that copy an existing body to a new body without modifying the existing body. A copy can be made of several bodies at once and the resulting new bodies can be translated or rotated at the same time.

“Merge” button 294, as shown in FIG. 6A, provides options that merge two manifold surfaces into a single non-manifold surface. Preferably, geometry is created and imported into FEA in a manifold state by default. The process of converting manifold to non-manifold geometry is referred to as “merging”, since it involves merging multiple geometric entities into single ones.

“Tweak” button 296, as shown in FIG. 6A, provides options that modify models by moving, offsetting or replacing surfaces, while extending the adjoining surfaces to fill the resulting gaps. This is useful for eliminating gaps between components, simplifying geometry or changing the dimensions of an object.

“Cut” button 298, as shown in FIG. 6A, provides options that cut off protrusions from model geometry to make them easily meshable.

### C. Virtual

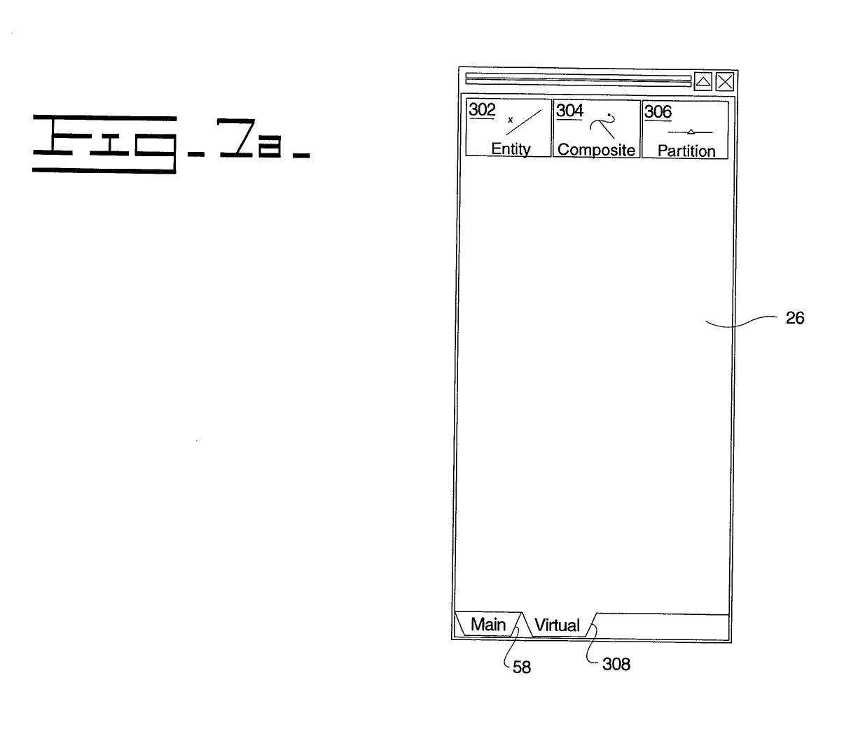

“Virtual” button 62, as shown in FIG. 4A, is for creation and manipulation of virtual geometry entities. The advantage of virtual geometry is that all operations are reversible. With standard geometry modification commands, changes are made to the underlying geometry representation and may be difficult to change once effected. With virtual geometry, the original solid model topology can be easily restored. This is useful when geometry modifications are made in order to apply a particular meshing scheme, for example. Virtual geometry can be applied and later removed once the part has been meshed. As shown in FIG. 7A, by selecting “Virtual” button 62 a new interface element, with a suite of buttons 302-306, associated with “Virtual” tab identifier 308 is illustrated for increased detailed control and ease of use. Buttons 302-306 consist of: “Entity” button 302 that provides a method for introducing new virtual geometry for use in defining locations at which to partition;

“Composite” button 304 that provides a method for combining a set of connected curves into a single composite curve, or a set of connected surfaces into a single surface; and “Partition” button 306 that provides a method for introducing additional topology into the model, to better constrain meshing algorithms and is accomplished by splitting or partitioning existing curves or surfaces.

### D. Groups

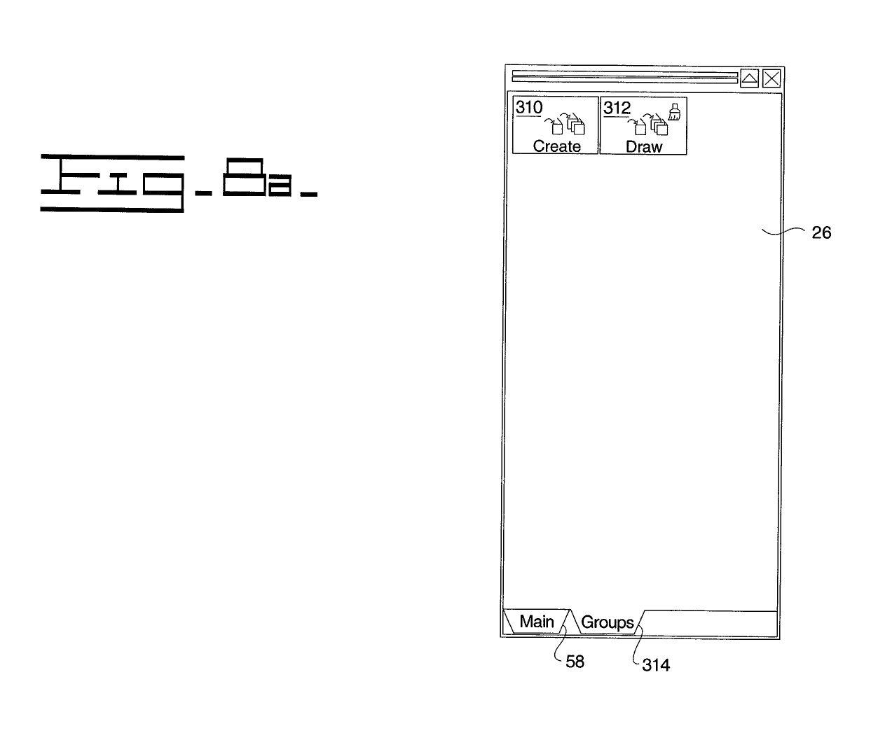

“Groups” button 63, as shown in FIG. 4A, provides the capability of performing operations on multiple geometric entities with minimal input as well as serving as a means for sorting geometric entities according to various criteria. As shown in FIG. 8A, by selecting “Groups” button 63 a new interface element, with a suite of buttons 310-312, associated with “Groups” tab identifier 314 is illustrated for increased detailed control and ease of use. Buttons 310-312 consist of: “Create” button 310 that provides a method for creating a grouping of entities; and “Draw” button 312 that provides a method for drawing a grouping in order to effectively visualize a desired model.

### E. Meshing

“Meshing” button 64, as shown in FIG. 4A, provides access to all of the mesh generation features in a FEA application. Meshing is discretizing a complex solid model into simple geometric, interconnected shapes, such as quadrilaterals, triangles (two-dimensional), hexahedrals or tetrahedrals (three-dimensional). The mesh can be used as an input to a FEA program to solve for stresses or strains in the model, for example.

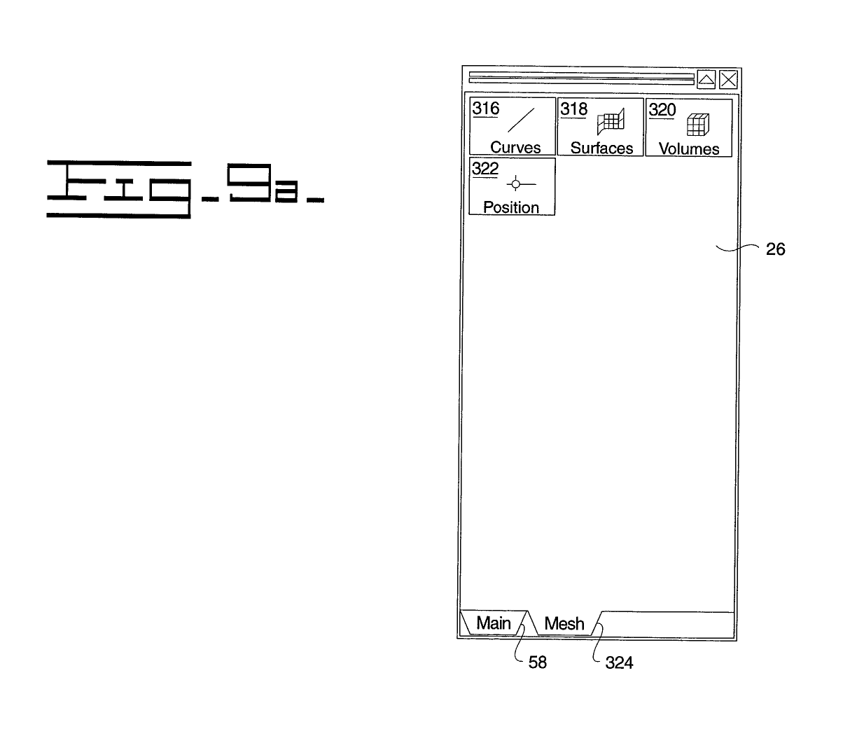

Geometric entities can be meshed with a wide variety of meshing schemes. As shown in FIG. 9A, by selecting “Meshing” button 64 a new interface element, with a suite of buttons 314-322, associated with “Mesh” tab identifier 324 is illustrated for increased detailed control and ease of use.

Buttons 314-322 consist of: “Curves” button 316 that provides a dialogue interface element for meshing and setting mesh properties for one or more curves; “Surfaces” button 318 that provides a dialogue interface element for meshing and setting mesh properties for one or more surfaces; “Volumes” button 320 that provides for meshing and setting mesh properties for one or more volumes; and “Position” button 322 that provides additional commands for modifying the location of nodes and elements after a mesh has been generated.

### F. Display

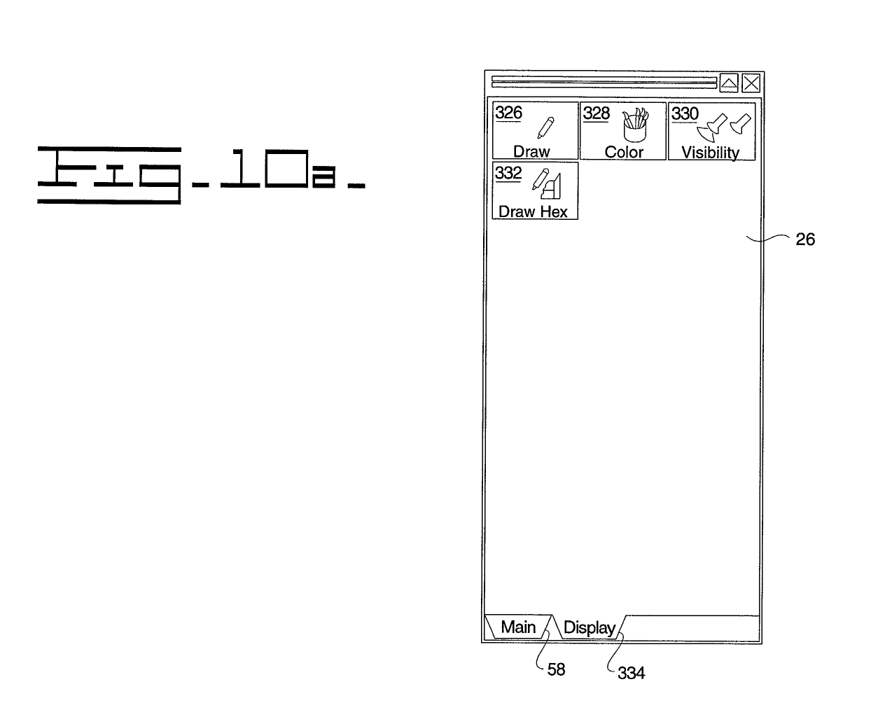

“Display” button 65, as shown in FIG. 4A, provides options to control the appearance of geometric entities and mesh entities. For example, individual or groups of entities can be displayed or their visibility turned on and off. As shown in FIG. 10A, by selecting “Display” button 65 a new interface element, with a suite of buttons 326-332, associated with “Display” tab identifier 334 is illustrated for increased detailed control and ease of use. Buttons 326-332 consist of: “Draw” button 326 that provides the capability, as is often necessary, to effectively visualize the model by drawing an entity by itself or several entities as a group; “Color” button 328 that allows users to define their own colors in addition to those defined by the FEA application; “Visibility” button 330 allows the visibility of geometric and mesh entities to be turned on or off, either individually, by entity type, by general entity class (mesh, geometry, etc.), or globally; and “Draw Hex” button 332 that provides the ability to propagate hexes given a starting face or surface and store them in groups.

### G. Import

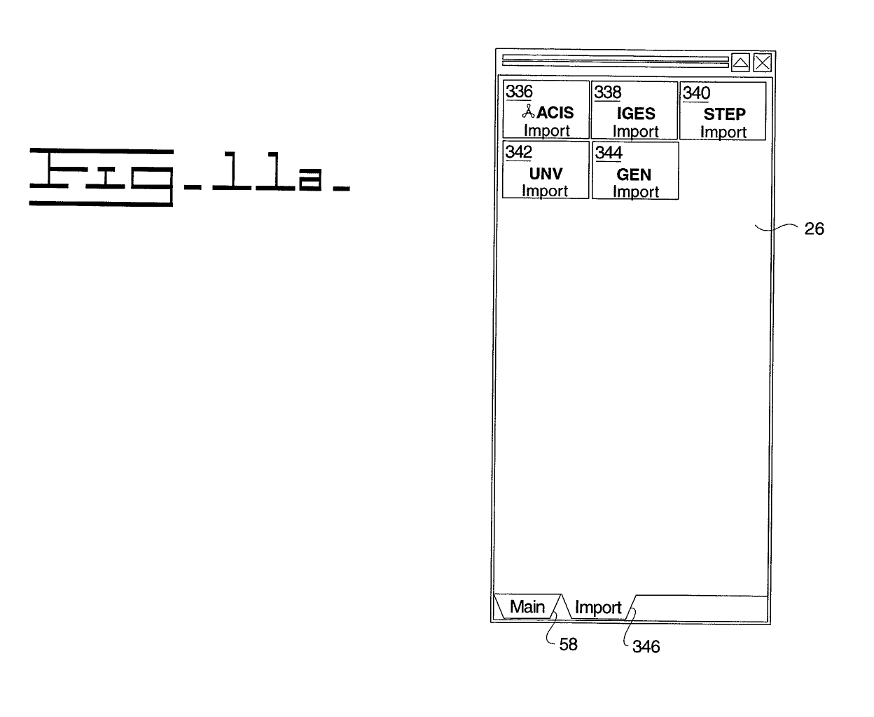

“Import” button 66, as shown in FIG. 4A, provides a variety of methods for importing geometry and meshes. As shown in FIG. 11A, by selecting “Import” button 66 a new interface element, with a suite of buttons 336-344, associated with “Import” tab identifier 346 is illustrated for increased detailed control and ease of use. Buttons 336-344 consist of: “ACIS Import” button 336 that provides the command to translate or read-in an ACIS files; “IGES Import” button 338 that provides bi-directional functionality for data translation between ACIS and the IGES (Initial Graphics Exchange Specification) format; “STEP Import” button 340 that provides bidirectional functionality for data translation between ACIS and the file format standards for STEP (an international standard); “UNV Import” button 342 that provides the command for importing SDRC I-DEAS universal files; and “GEN Import” button 344 that provides the command to import a mesh from an Exodus II (Genesis) format file.

### H. Validate

“Validate” button 67, as shown in FIG. 4A, provides the capability to validate geometry. Validating geometry comprises checking geometry and solid model topology for errors. For example, a sphere must have a non-zero radius and all curves in the solid model must lie on surfaces. As shown in FIG. 12A, by selecting “Validate” button 67, a new interface element, with “Geometry” button 348, associated with “Validate” tab identifier 350 is illustrated for increased detailed control and ease of use. “Geometry” button 348 allows for rigorous, higher level, checking of geometry.

### I. Export

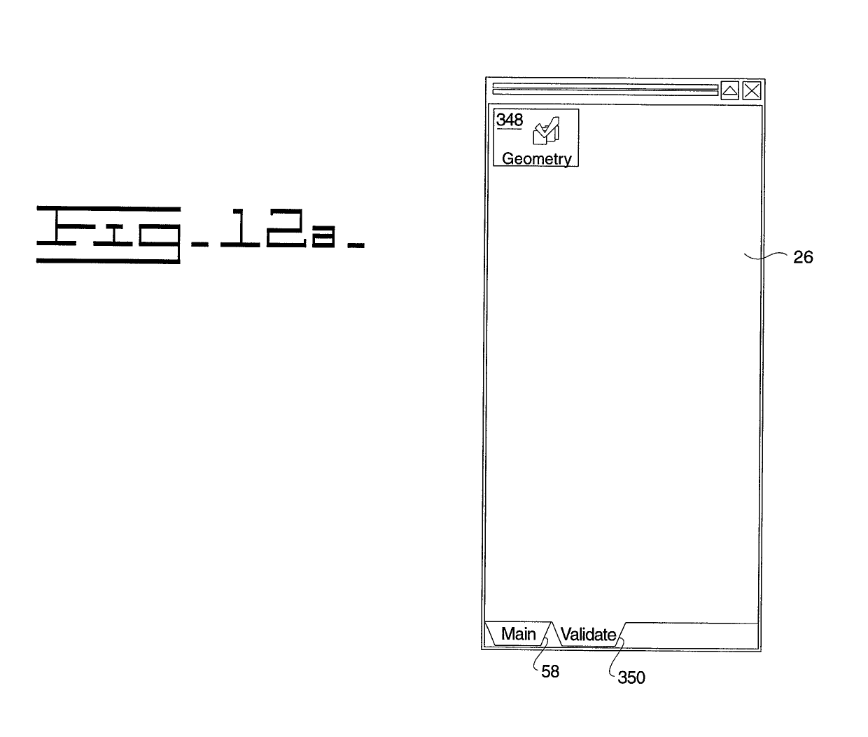

“Export” button 68, as shown in FIG. 4A, provides a variety formats for exporting geometry and mesh data. As shown in FIG. 13A, by selecting the export button 68 a new interface element, with a suite of buttons 352-362, associated with “Export” tab identifier 364 is illustrated for increased detailed control and ease of use. Buttons 352-362 consist of: “ACIS Export” button 352 that allows exportation from within a FEA application to the ACIS SAT (ascii) and SAB (binary) format which can be used to exchange geometry between ACIS-compliant applications; “IGES Export” button 354 that provides bi-directional functionality for data translation between ACIS and the IGES files; “STEP Export” button 356 that provides bi-directional functionality for data translation between ACIS and the file format standards for STEP; “I-DEAS Export” button 358 that provide the ability to directly write-out SDRC I-DEAS universal files; “PATRAN Export” button 360 that allows a PATRAN neutral file of the mesh to be exported; and “Genesis Export” button 362 that allows a model to be written to the Exodus II (Genesis) file format.

### J. Graphics

“Graphics” button 69, as shown in FIG. 4A, provides the ability to control graphics settings and although it has no new interface element with a suite of buttons for further command control, this can be easily added if further, more advanced command control is desired.

### K. Customize

“Customize” button 70, as shown in FIG. 4A, provides a new window (not shown) from which to customize various aspects of the graphical user interface, such as assigning an iconic button a valid set of commonly used FEA application commands which the user finds particularly useful. As with “Graphics” button 69, although “Customize” button 70 has no new interface element with a suite of buttons for further command control, this can be easily added if further, more advanced command control is desired.

### L. Settings

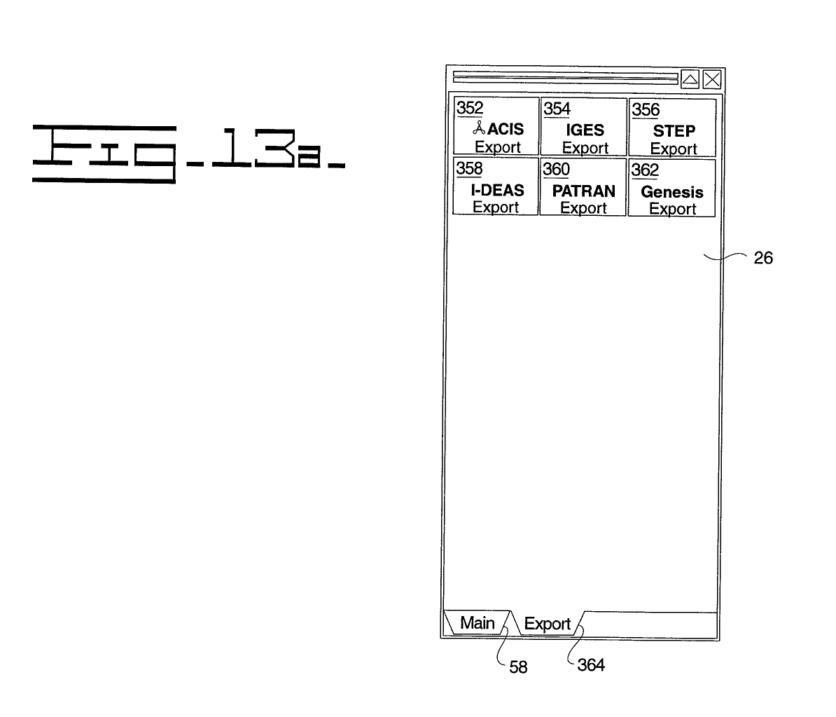

“Settings” button 71, as shown in FIG. 4A, provides the capability to set attributes that will be defined when saving and restoring Exodus II and ACIS file formats, for example. As shown in FIG. 14A, by selecting “Settings” button 71, a new interface element with “Attributes” button 366, associated with “Settings” tab identifier 366 is illustrated for increased detailed control and ease of use as well as for specifically setting particular attributes.

### M. Hardcopy

“Hardcopy” button 72, as shown in FIG. 4A, provides a quick way to immediately print the current contents of graphics window 22 and although it has no new interface element with a suite of buttons for further command control, this can be easily added if further, more advanced command control is desired.

### N. Clipboard

“Clipboard” button 73, as shown in FIG. 4A, provides a quick way to capture the current content of graphics window 22 to the Windows™ Clipboard. The Clipboard can in turn be inserted into any application document supporting the Windows™ Clipboard. Although “Clipboard” button 73 has no new interface element with a suite of buttons for further command control, this can be easily added if further, more advanced command control is desired.

### O. Measure

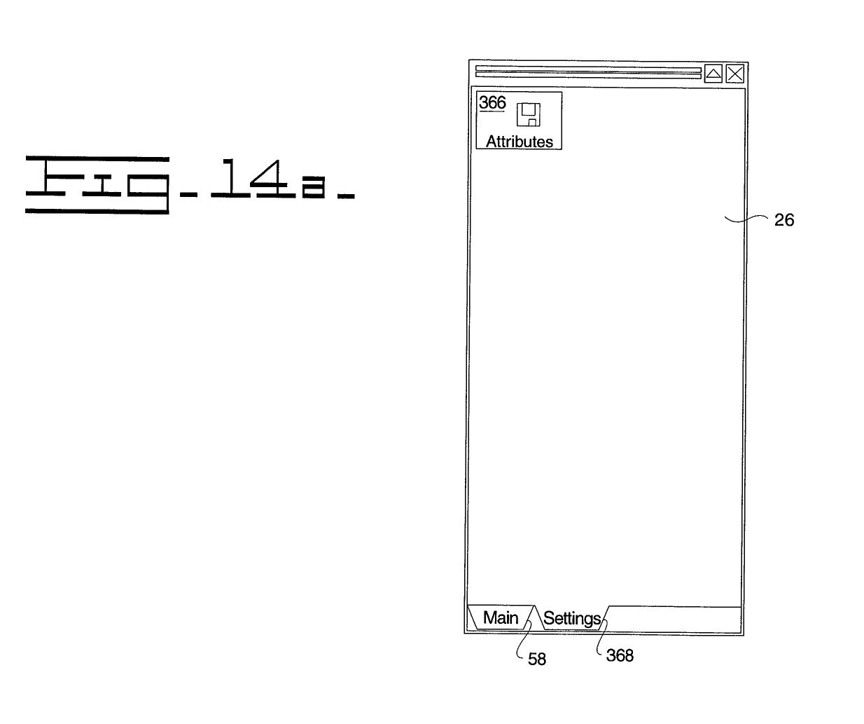

Finally, “Measure” button 74 in the task window 26 under “Main” tab identifier 58, as shown in FIG. 4A, upon selection, provides a new interface element with options for determining feature sizes within a current model, via “Measure” button 370, as well as provides facility for locating small features, via “Find Small” button 372, and determining where overlapping surfaces occur, via “Overlaps” button 374 as shown in FIG. 15A within “Measure” tab identifier 376 for increased detailed control and ease of use.

### PROPERTY INPUT WINDOW

Referring back again to FIG. 2, the next child window is property input window 28 which is attached to main graphics window 22 in a default location towards the lower left of the graphical user interface. As individually seen in FIG. 5A property input window 28 with its interface element and associated “Properties” tab identifier 400 displays iconic buttons as well as other inputs which control depiction and properties of an image within graphics window 22. Although property input window 28 is used primarily for meshing operations it may also be used for other finite element analysis operations.

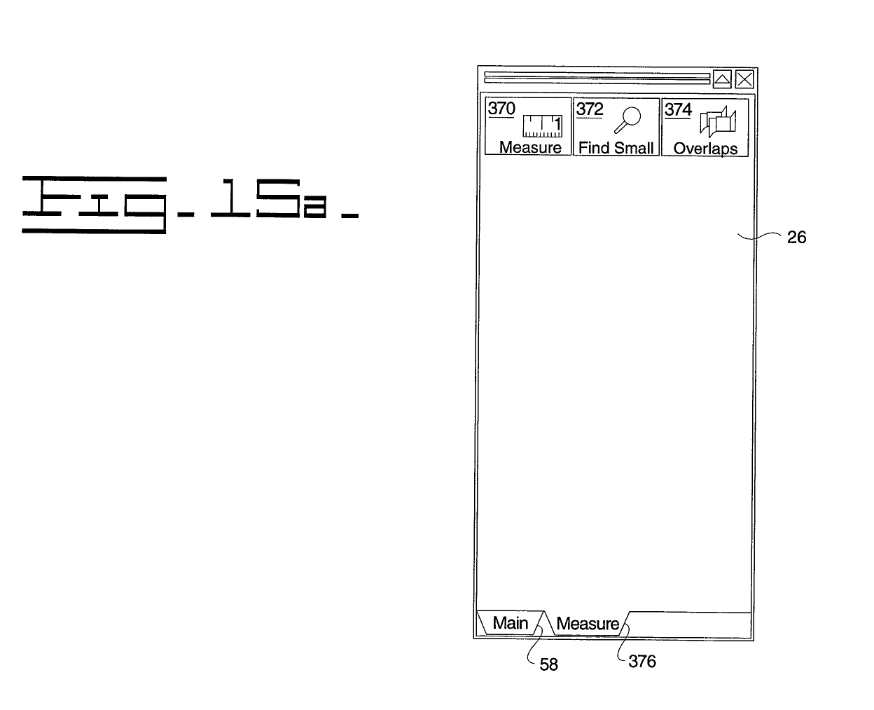

Initially, property input window 28 is disabled or “grayed out” and is automatically enabled as well as updated to reflect the settings or attributes of an entity (in this case a surface) selected in graphics window 22. Preferably, the property input window 28, as shown individual in FIG. 16A, will automatically update for selected bodies, volumes, and curves by default. The default can be easily changed, however, by selecting either all or some of the other entities such as a vertex, node, edge, face, or hex, for example. The entity type (“Surface”) and its ID (“1”), comprise the entity name/ID (“Surface 1”) which appears in fields 402 and 404 within FIG. 16A. It is to be understood that the user is able to freely change the name of any entity name/ID to another suitable or preferred entity name/ID by modifying the default entity name/ID in field 404.

The entity graphic button 406 to the right of field 404 is a clickable graphical representation of the active entity type and, in this particular case, because the entity is a surface, whether the entity is meshed

It is also to be understood that the graphical representation of entity graphic button 406 varies depending on the type of entity selected. For example, entity graphic button 406 can be a box to represent a body entity or a diagonal line to represent a curve. Accordingly, each particular entity has it's own unique image to correspond with particular entities features for ease of identification by the user. Note that if entity graphic button 406 in FIG. 16A was meshed, the entity graphic button 406 would appear with vertical and horizontal lines incorporated into the graphic to visually represent to the user that the entity selected is meshed.

Furthermore, as shown in FIG. 16A, the properties or attributes of the particular entity chosen from graphics window 22 can be changed by selecting or entering data into fields 408-416 if they are not disabled due to particular constraints or settings on an entity type. All fields 408-416 contain predefined values that are available via arrows 418. As previously stated, the fields 408-416 relate to certain properties or attributes of an entity. Fields 408-416 consist of: “Interval Count” field 408 which corresponds to the number of mesh entities that will fill the selected entity (e.g., how many finite element edges to break a curve into); “Interval Size“ field 410 which corresponds to the size of mesh entities that will fill the active entity (e.g., what size of finite element edges to break a curve into); “Interval Set” field 414 which defines under what circumstances the current intervals can be changed (e.g., whether the meshing capabilities of the FEA application can change the setting via some criteria or must the user have explicit control over the setting); and “Mesh Scheme” field 412 which corresponds to the desired mesh scheme such as mapping, sub-mapping, paving, sweeping, triangle primitive, circle primitive, pentagon primitive, tetrahedron primitive, morphing, mirroring, hextet plastering, trimeshing and tetmeshing, for example, all available via arrow 418 in “Mesh Scheme” field 412 depending upon the active entity type selected from graphics window 22 (e.g., specify to mesh a circular shape in a predefined manner using a template).

The last field in property input window 28 is “Smooth Scheme” field 416 which corresponds to the process of improving element quality after mesh generation. Several examples of smooth schemes include: laplacian, equipotential, centroid area pull, optimize jacobian, and winslow, for example, all available for selection via arrow 418 in “Smooth Scheme” field 416 depending upon the entity type selected. After proper entry into the enabled fields, the changes made to the properties of an entity can be applied and displayed in graphics window 22 by selecting the “Apply” button 420.

Prior to application of changes to fields 408-416, however, additional modification of a particular entity may occur via iconic buttons 422-448, to help a user identify and manipulate the active entity. As shown in FIG. 16A, iconic buttons 422-448 consist of: highlight-entity button 422 that draws the active entity in the current highlight color; draw-entity button 424 that draws only the active entity in graphics window 22; zoom-entity button 426 that displays a drop-down menu (not shown) of zoom/view related commands; list-entity button 428 that displays a drop-down menu (not shown) of listing commands that simply list details about the selected entity; delete-mesh button 430 that deletes the mesh on the active entity as well as intervals on any lower order geometric entity attached to the active entity; delete-entity-mesh button 432 that also deletes mesh on the active entity but does not delete the intervals on any lower order entity attached to the active entity; mesh-entity button 434 that meshes the active entity using the mesh scheme selected and any user defined intervals; delete-free-entity button 436 that deletes the active entity and any lower order entities attached to it; entity-color button 438 that sets the color of the active entity from a drop-down menu (not shown); preview-curve-mesh button 440 that displays in graphics window 22 the locations of nodes that would be generated in a subsequent mesh operation without actually creating such nodes to provide user feedback as to the potential density of the current interval settings; additional-commands button 442 that provides a drop-down menu (not shown) with a list of commands applicable to the active entity which change based upon the current entity type; fix-node-position button 444 that provides a drop-down menu (not shown) with commands allowing node positions to be fixed or free; mesh-multiple-entities button 446 that is a shortcut to the mesh commands within the task window 26 for multiple meshing operations; and smooth-entity-mesh button 448 that smoothes the nodes on the mesh of the active entity using the selected smoothing scheme from the “Smooth Scheme” field 416 within property input window 28.

### ENTITY TREE WINDOW

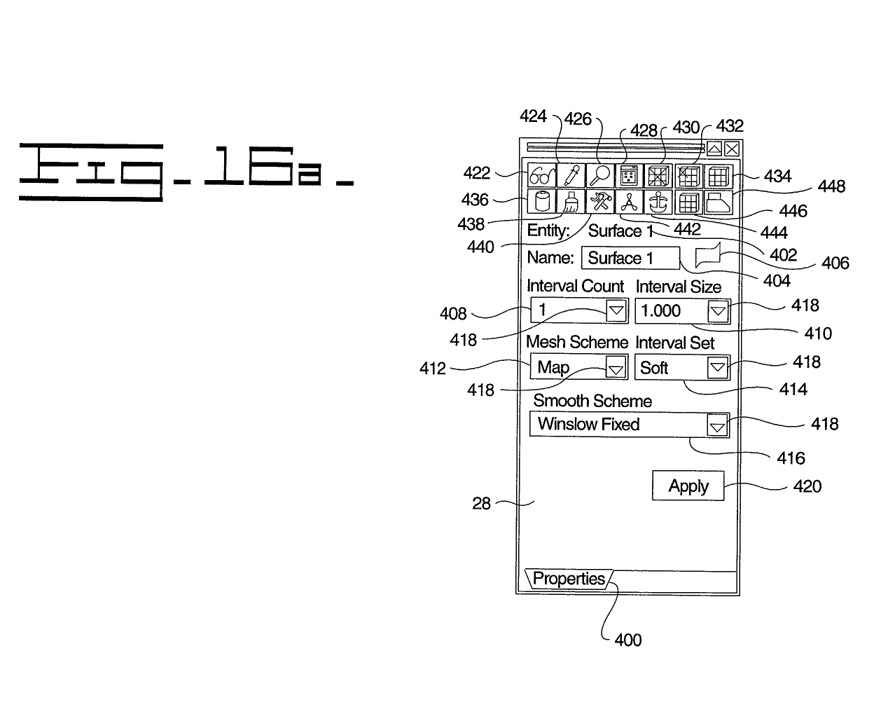

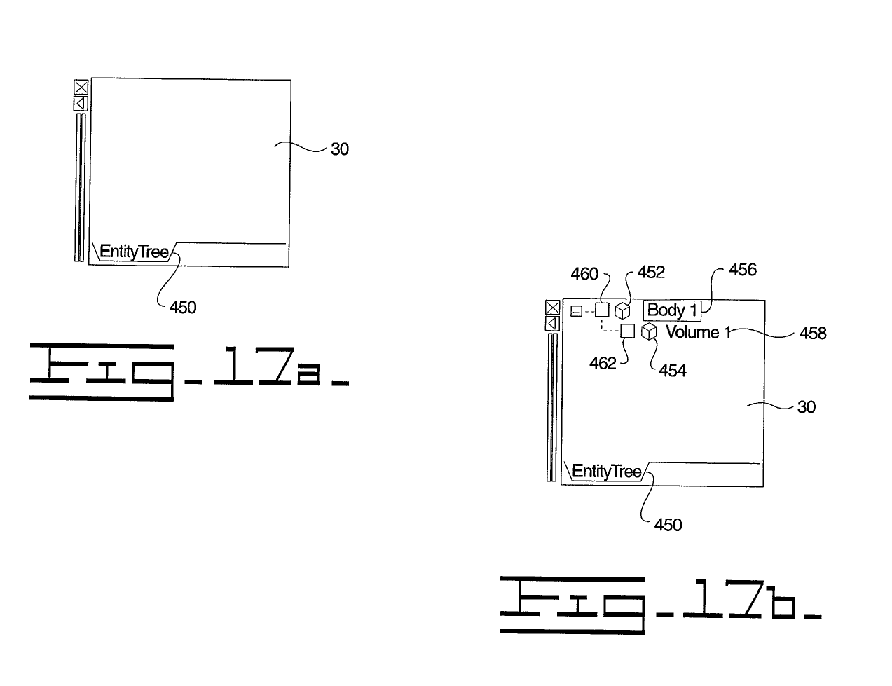

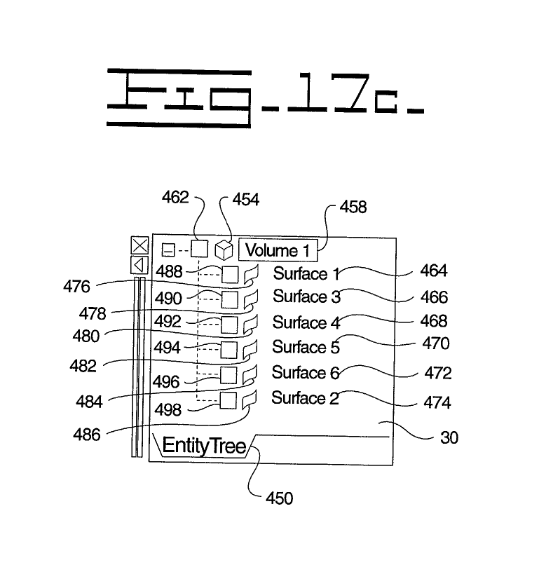

Referring back again to FIG. 2, entity tree window 30 is shown attached to the main graphics window 22 in a default location towards the bottom lower left comer of the graphical user interface. As individually seen in FIG. 17A, the entity tree window 30, with its interface element associated with “Entity Tree” tab identifier 450, is initially empty but automatically updates, to reflect the geometry entities and IDs of the currently selected active entity. As illustrated in FIG. 17B, by selecting a body, for example, within graphics window 22, the entity tree window 30 changes to display body ID icons 452, 454 along with the entity names/IDs 456, 458 as well as along with entity mesh status' via check boxes 460, 462. Check boxes 460, 462 allows a user to modify mesh status by simply selecting or checking a check box, such as 460 and/or 462, to mesh an entity or de-selects or unchecks the check box to eliminate the mesh. Thus, if an entity is already meshed, or becomes meshed, a check box will already be checked or become checked upon selection.

Similarly, selection of an entity name (456 and/or 458) highlights that particular entity in graphics window 22 as well as updates property input window 28 with that particular entities attributes.

Furthermore, by double-clicking or twice selecting entity name/ID 456 and/or 458, entity tree window 30 will update to reflect all associated child entities of that particular entity. For example, as illustrated in FIG. 17C, after twice selecting entity name/ID 458, entity tree window 30 is automatically updated to reflect child entity names/IDs 464-474, child ID icons 476-486, and child check boxes 488-498 of entity name 458. It is to be understood that this branching or drilling down to child entities can be executed to subsequent levels, such as grand-children entities, for example.

It is also to be understood that in the preferred embodiment, ID icons are of differing visual appearance, such as colors to reflect whether that particular entity is, for example, a “source” surface (e.g., green) or a “target” surface (e.g., magenta). For instance, a source surface is at the start of a “sweep” volume whereas a target surface is at the end of a sweep volume. These designations provide simple visual indicators for quick and user-friendly operation. Additional entity names/IDs can also be added to update entity tree window 30 by dragging and dropping text entities from the textual input window 24 or textual output window 32 to entity tree window 30. Again, this facilitates quick execution of commands in a user-friendly and efficient manner.

### TEXTUAL OUTPUT WINDOW

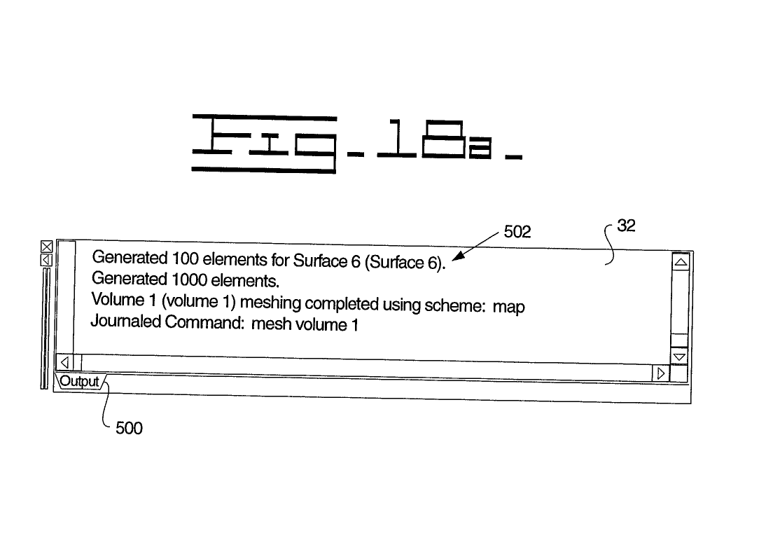

Referring back again to FIG. 2, textual output window 32 is shown attached to main graphics window 22 in a default location towards the bottom right comer of the graphical user interface. As individually seen in FIG. 18A, textual output window 32 with its interface element and associated “Output” tab identifier 500 provides complete textual feedback and direct indication of activity executed by the FEA application. For example, as shown in FIG. 18A, the uppermost output line 502 in textual output window 32 indicates that the application has “Generated 100 elements for Surface 6 (Surface 6).” Textual output window 32 can be very useful in understanding how a FEA application dealt with a command entered by the user, whether entered via textual input window 24, task window 26, property input window 28, entity tree window 30, or toolbars 34 and drop-down menu bars 36, and thus can be extremely helpful, for example, in determining why the geometry did not mesh properly. Further, as with the textual input window 24, textual commands can be selected and dragged and dropped in any desired location accepting such textual commands.

### TOOLBARS AND DROP-DOWN MENU BARS

Referring again to FIG. 2, toolbars 34 and drop-down menu bars 36 are shown attached to main graphics window 22 in a default location towards the top of the graphical user interface. They are organized so as to not disrupt the user work workspace or create potentially confusing borders.

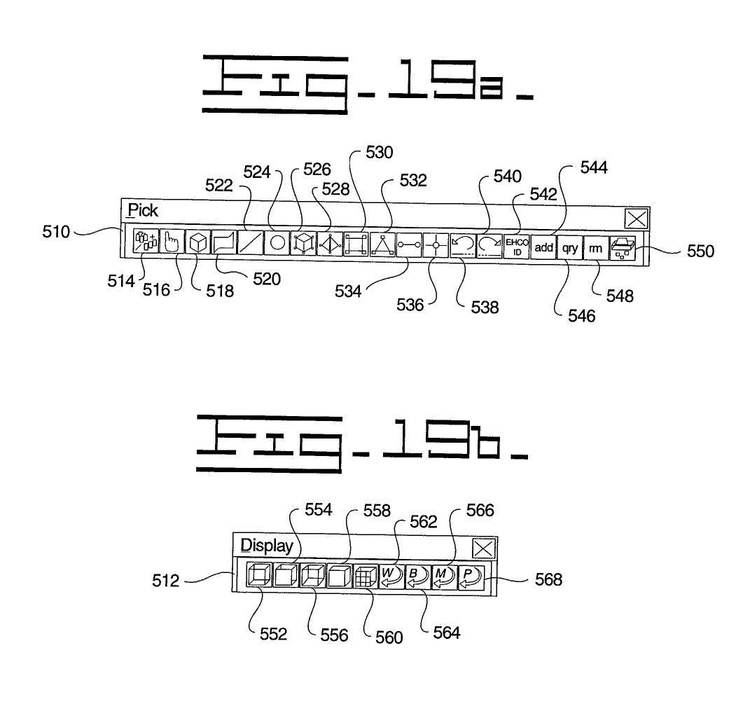

As shown in FIG. 2, and individually in FIGS. 19A and 19B, toolbars 34 provide an effective way for accessing frequently used commands and include, specifically, pick toolbar 510 and display toolbar 512. It is important to understand that there are a multitude of other toolbars, in addition to pick toolbar 510 and display toolbar 512, that may be used in the toolbars 34 area. Preferably, pick toolbar 510 and display toolbar 512 are the default toolbars appearing within toolbars 36 area upon launch of a FEA application.

As individually shown in FIG. 19A, pick toolbar 510 contains a number of selection mode icons 514-536, one of which must be chosen before selecting any entity from graphics window 22. The selection mode chosen within pick toolbar 510 dictates which entity types are available for selection in graphics window 22. Pick toolbar 510, therefore, is primarily used to change entity selection modes. The selection mode icons 514-536 preferably available within pick toolbar 510, within the toolbars 34 area, include the following entity-type icons: groups icon 514, bodies icon 516, volumes icon 518, surfaces icon 520, curves icon 522, vertex icon 524, hex-elements icon 526, tet-elements icon 528, quad-faces icon 530, triangle-faces icon 532, edges icon 534, and nodes icon 536. The other icons 538-550 allow for general manipulation of entity selections, such as selecting the next entity or selecting the previous entity, for example.

As individually shown in FIG. 19B, display toolbar 512 contains display icons 552-568. The first five display icons 552-560 in display toolbar 512 change the display mode, while the last four display icons 562-568 dictate how an image will appear during mouse-based navigation. Specifically, the first five display icons 552-560 consist of: wireframe icon 552 that displays transparent surfaces and is preferably a default because it is generally the fastest graphics mode in FEA applications; smooth-shade icon 554 that displays surfaces as filled and shaded; true-hidden-line icon 556 that displays surfaces that are not visible from a current graphics window 22 view with dashed lines; hidden-line icon 558 that hides surfaces that are hidden or not visible from a current view; and graphics-facet-display-mode icon 560 that draws shaded and filled surfaces after meshing.

On the other hand, the last four display icons 562-568 control model display during mouse-based rotation, and consist of: wireframe-geometry-mode icon 562 that makes any visible mesh disappear and the display change to a wireframe drawing of the visible geometry as with the wireframe icon 552; body-bounding-box-mode icon 564 that draws a separate bounding box (e.g., the smallest orthogonal box that encloses a body, to greatly simplify the display thus improving graphics performance) for each body in a model within graphics window 22; model-bounding-box-mode icon 566 that draws a single box representing the bounding box of all existing geometry; and persistent-geometry-mode icon 568 that allows model rotations without switching to a simpler display mode.

Lastly, as shown in FIG. 2, drop-down menu bars 36 provide additional ways for a user to access essentially all FEA application commands. These menus are provided as a convenience to the user. Preferably, all commands provided in task window 26 are provided in the drop-down menu bars 36, only in a drop-down menu format.

### Industrial Applicability

The described graphical user interface method and apparatus for interaction with finite element analysis applications provides a highly effective manner of interacting with the computer and finite element analysis software by improving the ergonomic, aesthetic, and instinctive feel of the graphical user interface. The disclosed graphical user interface permits users to readily comprehend how to efficiently create, modify, and manipulate finite elements.

This is particularly useful for a design engineer using finite element analysis software, whether a novice or expert.

One important example is represented by prior graphical user interface methods and apparatus which allowed entry of commands for creation, modification, and manipulations via merely a textual command line window. It is not always practical to reach or teach every individual for training and, given time constraints in an engineering design environment, it is important that a user be able to quickly create and modify finite element analysis models and be confident that he or she understands, without undue effort or memorization of textual commands, the methods available for creation and manipulation in a finite element analysis application. Failure to provide the capability to quickly, efficiently, and easily utilize finite elements analysis software applications can delay engineering design projects, and, in turn, production timetables, causing large economic loss.

Additionally, the graphical user interface of the disclosed invention is effective for large organizations, in particular, because of the large number of people and time involved in engineering design. Time saved in training because of an easy to use method and/or apparatus, and in making quicker and more correct design models, has the potential for large savings. The disclosed invention provides excellent opportunities for savings to those using finite element analysis applications.

The invention and the manner and process of making and using it are now described in such full, clear, concise and exact terms as to enable any person skilled in the art to which it pertains, to make and use the same. It is to be understood that the foregoing describes preferred embodiments of the present invention and that modifications may be made therein without departing from the spirit or scope of the present invention as set forth in the claims. It is also to be understood that the present invention be limited not by the specific disclosure herein, but by the scope of the appended claims. To particularly point out and distinctly claim the subject matter regarded as invention, the following claims conclude this specification.

What is claimed is:

1. A method of presenting a graphical user interface for a finite element analysis application on an electronic display device, comprising:
launching a parent graphics window on said electronic display device for displaying an image; and
attaching a property input window to said parent graphics window for displaying and manipulating settings and attributes of an entity selected within said parent graphics window, wherein first interface element of said property input window includes at least one of said active entity name/ID field and entity graphic button and interval count field and interval size field and interval set field and mesh scheme field and smooth scheme field.

2. The method of claim 1 further comprising attaching a task window to said parent graphics window for geometry creation, manipulation, and meshing of said entity within said parent graphics window, wherein a first interface element of said task window having a first tab identifier includes at least one of a first iconic button, adapted to providing creation capabilities of at least one of a vertex entity and curve entity and surface entity and volume entity and brick entity and sphere entity and cylinder entity and pyramid entity and torus entity and frustum entity, and a second iconic button adapted to providing modification capabilities of entities by at least one of webcutting and imprinting and cleaning and combining and boolean operations and healing and positioning and scaling and separating and splitting and copying and merging and tweaking.

3. The method of claim 1 further comprising attaching a textual input window to said parent graphics window wherein first interface element of said textual input window includes a command line for entry of textual commands for said finite element analysis application execution.

4. The method of claim 1 further comprising attaching an entity tree window to said parent graphics window for displaying a graphical hierarchical representation of the parent child relationship of said entity selected within said graphics window or said entity tree window, wherein first interface element of said entity tree window includes parent and child entity names/IDs, ID icons, and mesh status check boxes.

5. The method of claim 1 further comprising attaching a textual output window to said parent graphics window wherein first interface element of said textual output window includes an output line having textual feedback of activity executed by said finite element analysis application.

6. The method of claim 2 wherein said task window includes an advanced selection dialogue interface for selection of said entity in said graphics window that is particularly difficult to select yet is required for finite element analysis application execution and wherein said advanced selection dialogue interface includes a list box for displaying a current list of at least one said entity available for a particular FEA application command, and a required-entity field for displaying the number and type of said entity required for said finite element analysis application execution.

7. The method of claim 2 further comprising outputting a filter picking dialog interface window from said task window for filtering entities to parse out entities that match or do not match said entity characteristics, wherein said filter picking dialog interface window includes a filter-criteria field for including or excluding filtered entities and performing specified actions on said including or excluding filtered entities, and a register list box for listing at least one registered filter for limiting subsequent selection operations in said graphics window to those that meet said filter criteria.

8. The method of claim 7 wherein said registered filter is deactivated, so as to not limit said subsequent selection operations in said graphics window, while remaining a registered filter in said filter picking dialog interface window.

9. A computer-readable medium having computer-executable instructions for performing the steps recited in claim 1.

10. An apparatus for presenting a graphical user interface for a finite element analysis application on an electronic display device, the apparatus comprising a computer programmed to:
launch a parent graphics window on said electronic display device for displaying an image; and
attach a property input window to said parent graphics window for displaying and manipulating settings and attributes of an entity selected within said parent graphics window, wherein first interface element of said property input window includes at least one of said active entity name/ID field and entity graphic button and interval count field and interval size field and interval set field and mesh scheme field and smooth scheme field.

11. The apparatus of claim 10 further comprising a computer programmed to:
attach a task window to said parent graphics window for geometry creation, manipulation, and meshing of said entity within said parent graphics window, wherein a first interface element of said task window having a first tab identifier includes at least one of a first iconic button, adapted to providing creation capabilities of at least one of a vertex entity and curve entity and surface entity and volume entity and brick entity and sphere entity and cylinder entity and pyramid entity and torus entity and frustum entity, and a second iconic button adapted to providing modification capabilities of entities by at least one of webcutting and imprinting and cleaning and combining and boolean operations and healing and positioning and scaling and separating and splitting and copying and merging and tweaking.

12. The apparatus of claim 10 further comprising a computer programmed to:
attach a textual input window to said parent graphics window wherein first interface element of said textual input window includes a command line for entry of textual commands for said finite element analysis application execution.

13. The apparatus of claim 10 further comprising a computer programmed to:
attach an entity tree window to said parent graphics window for displaying a graphical hierarchical representation of the parent child relationship of said entity selected within said graphics window or said entity tree window, wherein first interface element of said entity tree window includes parent and child entity names/IDs, ID icons, and mesh status check boxes.

14. The apparatus of claim 10 further comprising a computer programmed to:
attach a textual output window to said parent graphics window wherein first interface element of said textual output window includes an output line having textual feedback of activity executed by said finite element analysis application.

15. The apparatus of claim 11 wherein said task window includes an advanced selection dialogue interface for selection of said entity in said graphics window that is particularly difficult to select yet is required for finite element analysis application execution and wherein said advanced selection dialogue interface includes a list box for displaying a current list of at least one said entity available for a particular FEA application command, and a required-entity field for displaying the number and type of said entity required for said finite element analysis application execution.

16. The apparatus of claim 11 further comprising a computer programmed to:
output a filter picking dialog interface window from said task window for filtering entities to parse out entities that match or do not match said entity characteristics, wherein said filter picking dialog interface window includes a filter-criteria field for including or excluding filtered entities and performing specified actions on said including or excluding filtered entities, and a register list box for listing at least one registered filter for limiting subsequent selection operations in said graphics window to those that meet said filter criteria.

17. The apparatus of claim 16 wherein said registered filter is deactivated, so as to not limit said subsequent selection operations in said graphics window, while remaining a registered filter in said filter picking dialog interface window.

18. A method of presenting a graphical user interface tabbed-based menuing system on an electronic display device, comprising:
launching a parent window on said electronic display device for displaying an image; and
attaching a child window to said parent window wherein said child window includes a first interface element having a first tab identifier and at least one iconic button wherein selection of said at least one iconic button associated with said first interface element outputs a second interface element having a second tab identifier wherein said second interface element overlaps said first interface element except for said first tab identifier.

19. The method of claim 18, further comprising alternating between said first interface element and said second interface element by selecting said first tab identifier and said second tab identifier, respectively.

20. The method of claim 18, wherein said first tab identifier and said second tab identifier are oriented at bottom of said first interface element and said second interface element, respectively.

21. A computer-readable medium having computer-executable instructions for performing the steps recited in claim 18.

22. An apparatus for presenting a graphical user interface tabbed-based menuing system on an electronic display device, the apparatus comprising a computer programmed to:
launch a parent window on said electronic display device for displaying an image; and
attach a child window to said parent window wherein said child window includes a first interface element having a first tab identifier and at least one iconic button wherein selection of said at least one iconic button associated with said first interface element outputs a second interface element having a second tab identifier wherein said second interface element overlaps said first interface element except for said first tab identifier.

23. The apparatus of claim 22, further comprising a computer programmed to:
alternate between said first interface element and said second interface element by selecting said first tab identifier and said second tab identifier, respectively.

24. The apparatus of claim 22, wherein said first tab identifier and said second tab identifier are oriented at bottom of said first interface element and said second interface element, respectively.
